(19) United States
(12) Patent Application Publication
(10) Pub. No.: US 2024/0413342 A1
(43) Pub. Date: Dec. 12, 2024

(54) STORAGE BATTERY ELECTRODE, MANUFACTURING METHOD THEREOF, STORAGE BATTERY, AND ELECTRONIC DEVICE

(71) Applicant: SEMICONDUCTOR ENERGY LABORATORY CO., LTD., Atsugi-shi (JP)

(72) Inventors: Tatsuya IKENUMA, Kakegawa (JP); Takahiro KAWAKAMI, Atsugi (JP); Yohei MOMMA, Isehara (JP); Teruaki OCHIAI, Atsugi (JP)

(21) Appl. No.: 18/810,764

(22) Filed: Aug. 21, 2024

Related U.S. Application Data
(63) Continuation of application No. 16/861,306, filed on Apr. 29, 2020.
Application No. 16/861,306 is a continuation of application No. 15/914,612, filed on Mar. 7, 2018, now abandoned.
Application No. 15/914,612 is a division of application No. 14/885,583, filed on Oct. 16, 2015, now abandoned.

(30) Foreign Application Priority Data
Oct. 24, 2014 (JP) 2014-217227

(51) Int. Cl. H01M 4/62; H01M 4/04; H01M 4/139; H01M 10/052

(52) U.S. Cl. CPC H01M 4/625; H01M 4/0404; H01M 4/139; H01M 4/621; H01M 10/052; H01M 4/623; H01M 2220/30; Y02E 60/10; Y02P 70/50

(57) ABSTRACT

In manufacture of a storage battery electrode containing graphene as a conductive additive, the efficiency of reduction of graphene oxide under mild conditions is increased, and cycle characteristics and rate characteristics of a storage battery are improved. Provided is a manufacturing method of a storage battery electrode. In the manufacturing method, a first mixture containing an active material, graphene oxide, and a solvent is formed; a reducing agent is added to the first mixture and the graphene oxide is reduced to form a second mixture; a binder is mixed with the second mixture to form a third mixture; and the third mixture is applied to a current collector and the solvent is evaporated to form an active material layer.

### CROSS-REFERENCE TO RELATED APPLICATION

This Application is a Continuation of application Ser. No. 16/861,306 filed Apr. 29, 2020,which is Continuation of application Ser. No. 15/914,612 filed Mar. 7, 2018, now abandoned and which is a Divisional of application Ser. No. 14/885,583 filed Oct. 16, 2015, now abandoned and which claims benefit to the Japanese Patent Application No. 2014-217227 filed on Oct. 24, 2014, the contents of all of which are incorporated herein in their entireties by reference.

### BACKGROUND OF THE INVENTION

### 1. Field of the Invention

One embodiment of the present invention relates to a storage battery electrode, a manufacturing method thereof, a storage battery, and an electronic device.

Note that one embodiment of the present invention is not limited to the above technical field. One embodiment of the invention disclosed in this specification and the like relates to an object, a method, or a manufacturing method. One embodiment of the present invention relates to a process, a machine, manufacture, or a composition of matter. Specific examples of the technical field of one embodiment of the present invention disclosed in this specification include a semiconductor device, a display device, a light-emitting device, a power storage device, a memory device, a method for driving any of them, and a method for manufacturing any of them.

### 2. Description of the Related Art

With the recent rapid spread of portable electronic devices such as mobile phones, smartphones, electronic book (e-book) readers, and portable game machines, secondary batteries for drive power sources have been increasingly required to be smaller and to have higher capacity. Nonaqueous secondary batteries typified by lithium-ion secondary batteries, which have advantages such as high energy density and high capacity, have been widely used as secondary batteries for portable electronic devices.

Lithium-ion secondary batteries, which are nonaqueous secondary batteries, are widely used because of their high energy density. A lithium-ion secondary battery includes a positive electrode containing an active material such as lithium cobalt oxide (LiCoO₂) or lithium iron phosphate (LiFePO₄), a negative electrode containing an active material such as graphite capable of reception and extraction of lithium ions, a nonaqueous electrolytic solution in which an electrolyte formed of a lithium salt such as LiBF₄ or LiPF₆ is dissolved in an organic solvent such as ethylene carbonate or diethyl carbonate, and the like. The lithium-ion secondary battery is charged and discharged in such a way that lithium ions in the secondary battery move between the positive electrode and the negative electrode through the nonaqueous electrolytic solution and inserted into or extracted from the active materials of the positive electrode and the negative electrode.

A binder is mixed into the positive electrode or the negative electrode in order that active materials can be bound to each other or an active material layer and a current collector can be bound. Since the binder is generally an organic high molecular compound such as polyvinylidene fluoride (PVdF) which has an insulating property, the electric conductivity of the binder is extremely low. Thus, as the ratio of the amount of the binder to the amount of the active material is increased, the ratio of the amount of the active material in the electrode is relatively decreased, resulting in lower discharge capacity of the secondary battery.

Hence, by mixture of a conductive additive such as acetylene black (AB) or graphite particles, the electric conductivity between active materials or between an active material layer and a current collector can be improved. Thus, an active material layer with high electrical conductivity can be provided (see Patent Document 1).

An electrode containing graphene as a conductive additive has been developed. Patent Document 2 discloses an electrode manufacturing method in which graphene oxide (GO), an active material, and a binder are mixed and then GO is reduced. By this manufacturing method, an active material layer having high electrical conductivity only with a small amount of the conductive additive can be provided.

### REFERENCE

### Patent Documents

[Patent Document 1] Japanese Published Patent Application No. 2002-110162
[Patent Document 2] Japanese Published Patent Application No. 2014-007141

### SUMMARY OF THE INVENTION

To improve the performance of a storage battery containing graphene as a conductive additive, it is required to develop a manufacturing method of an electrode, with which graphene oxide can be sufficiently reduced. It is also required to simplify a manufacturing method of an electrode to facilitate mass production of storage batteries.

In view of the above, an object of one embodiment of the present invention is to provide a manufacturing method of a storage battery electrode, with which graphene oxide can be efficiently reduced. Another object of one embodiment of the present invention is to provide a manufacturing method of a storage battery electrode having low internal impedance. Another object of one embodiment of the present invention is to improve cycle characteristics of a storage battery. Another object of one embodiment of the present invention is to improve rate characteristics of a storage battery.

Another object of one embodiment of the present invention is to simplify a manufacturing method of a storage battery electrode containing graphene as a conductive additive. Another object of one embodiment of the present invention is to provide a manufacturing method of a storage battery electrode, with which graphene oxide is reduced under mild conditions. Another object of one embodiment of the present invention is to simplify a manufacturing method of a storage battery.

Another object of one embodiment of the present invention is to provide a storage battery electrode with a uniform thickness. Another object of one embodiment of the present invention is to provide a storage battery electrode with high strength and a storage battery with high strength.

Another object of one embodiment of the present invention is to provide a novel electrode, a novel storage battery, a novel manufacturing method of an electrode, or the like. Note that the descriptions of these objects do not preclude the existence of other objects. In one embodiment of the present invention, there is no need to achieve all the objects. One embodiment of the present invention achieves at least one of the above objects. Other objects will be apparent from and can be derived from the descriptions of the specification, the drawings, the claims, and the like.

One embodiment of the present invention is a manufacturing method of a storage battery electrode. In the manufacturing method, a first mixture containing an active material, graphene oxide, and a solvent is formed; a reducing agent is added to the first mixture to form a second mixture; a binder is mixed with the second mixture to form a third mixture; and the third mixture is applied to a current collector and the solvent is evaporated to form an active material layer.

One embodiment of the present invention is the above manufacturing method of a storage battery electrode, in which the solvent is evaporated by heating at a temperature higher than or equal to room temperature and lower than or equal to 100 □C.

One embodiment of the present invention is a storage battery electrode including a current collector and an active material layer. The active material layer contains an active material, a conductive additive containing graphene, a binder, and a reducing agent.

One embodiment of the present invention is a storage battery electrode including a current collector and an active material layer. The active material layer contains an active material, a conductive additive containing graphene, a binder, and an oxidized derivative of a reducing agent.

One embodiment of the present invention is a storage battery including a first electrode and a second electrode. The first electrode is any one of the above electrodes. The first electrode has a function of operating as one of a positive electrode and a negative electrode. The second electrode has a function of operating as the other of the positive electrode and the negative electrode.

One embodiment of the present invention is an electronic device including the storage battery with the above structure and a display panel, a light source, an operation key, a speaker, or a microphone.

In any of the above, the reducing agent is preferably at least one of ascorbic acid, hydrazine, dimethyl hydrazine, hydroquinone, sodium tetrahydroborate (NaBH₄), lithium aluminum hydride (LiAlH₄), and N,N-diethylhydroxylamine.

One embodiment of the present invention makes it possible to reduce graphene oxide contained in an active material layer efficiently and to construct a network of three-dimensional electric conduction paths in an active material layer. Accordingly, one embodiment of the present invention can provide an electrode having low internal impedance, can improve cycle characteristics of a storage battery, and can improve rate characteristics of a storage battery.

One embodiment of the present invention makes it possible to simplify a manufacturing method of an electrode containing graphene as a conductive additive and to provide a manufacturing method of an electrode, with which graphene oxide is reduced under mild conditions. Accordingly, one embodiment of the present invention can simplify a manufacturing method of a storage battery.

One embodiment of the present invention makes it possible to prevent a mixture used for forming an active material layer from being a strongly basic mixture, to prevent aggregation of an active material in an active material layer, and to prevent a binder from being gelled. Accordingly, one embodiment of the present invention can provide an electrode including an active material layer with a uniform thickness and can provide an electrode with high strength and a storage battery with high strength.

With one embodiment of the present invention, a novel electrode, a novel secondary battery, a novel manufacturing method of an electrode, or the like can be provided. Note that the descriptions of these effects do not preclude the existence of other effects. One embodiment of the present invention does not necessarily have all the effects. Other effects will be apparent from and can be derived from the descriptions of the specification, the drawings, the claims, and the like.

### BRIEF DESCRIPTION OF THE DRAWINGS

FIG. 1 illustrates a manufacturing method of a storage battery electrode.

FIGS. 2A to 2C illustrate a storage battery electrode.

FIG. 3 illustrates a storage battery electrode.

FIGS. 4A and 4B illustrate a coin-type storage battery.

FIG. 5 illustrates a laminated storage battery.

FIGS. 6A and 6B illustrate a laminated storage battery.

FIGS. 7A and 7B illustrate cylindrical storage batteries.

FIG. 8 illustrates examples of electric devices.

FIGS. 9A to 9C illustrate an example of an electric device.

FIGS. 10A and 10B illustrate an example of an electric device.

FIG. 11 is a block diagram illustrating one embodiment of the present invention.

FIGS. 12A to 12C are conceptual diagrams each illustrating one embodiment of the present invention.

FIG. 13 is a circuit diagram illustrating one embodiment of the present invention.

FIG. 14 is a circuit diagram illustrating one embodiment of the present invention.

FIGS. 15A to 15C are conceptual diagrams each illustrating one embodiment of the present invention.

FIG. 16 is a block diagram illustrating one embodiment of the present invention.

FIG. 17 is a flow chart illustrating one embodiment of the present invention.

FIGS. 18A and 18B are graphs showing cycle characteristics.

FIGS. 19A to 19C are graphs showing rate characteristics.

### DETAILED DESCRIPTION OF THE INVENTION

Embodiments will be described below with reference to drawings. However, the embodiments can be implemented in many different modes, and it will be readily appreciated by those skilled in the art that modes and details thereof can be changed in various ways without departing from the spirit and scope of the present invention. Thus, the present invention should not be interpreted as being limited to the following description of the embodiments.

Note that in the structures of the invention described below, the same portions or portions having similar functions are denoted by the same reference numerals in different drawings, and description of such portions is not repeated. Furthermore, the same hatch pattern is applied to similar functions, and these are not denoted by particular reference numerals in some cases.

Note that in the drawings used in this specification, the thicknesses of films, layers, and substrates and the sizes of components (e.g., the sizes of regions) are exaggerated for simplicity in some cases. Therefore, the sizes of the components are not limited to the sizes in the drawings and relative sizes between the components.

Note that the ordinal numbers such as “first” and “second” in this specification and the like are used for convenience and do not denote the order of steps, the stacking order of layers, or the like. Therefore, for example, description can be made even when “first” is replaced with “second” or “third”, as appropriate. In addition, the ordinal numbers in this specification and the like are not necessarily the same as those which specify one embodiment of the present invention.

### Embodiment 1

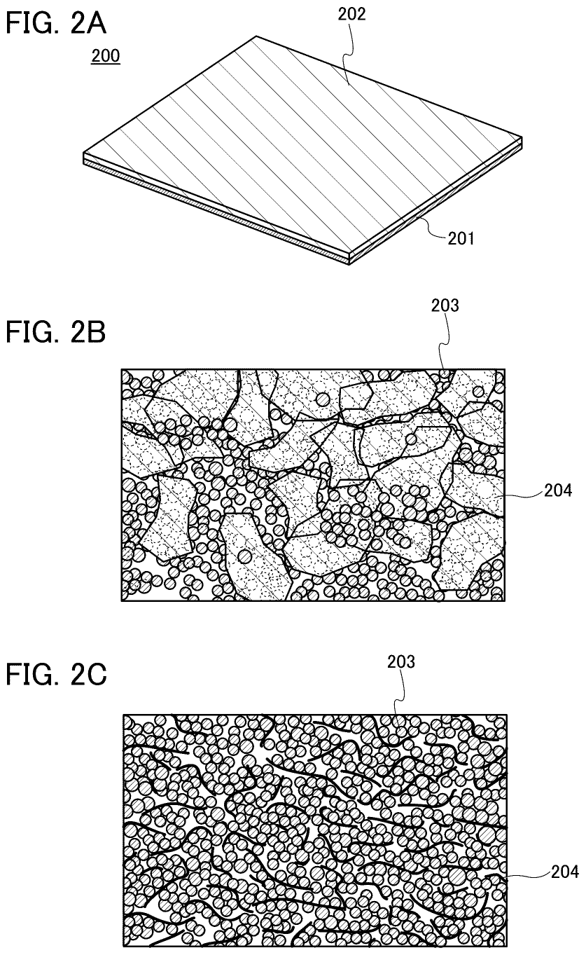

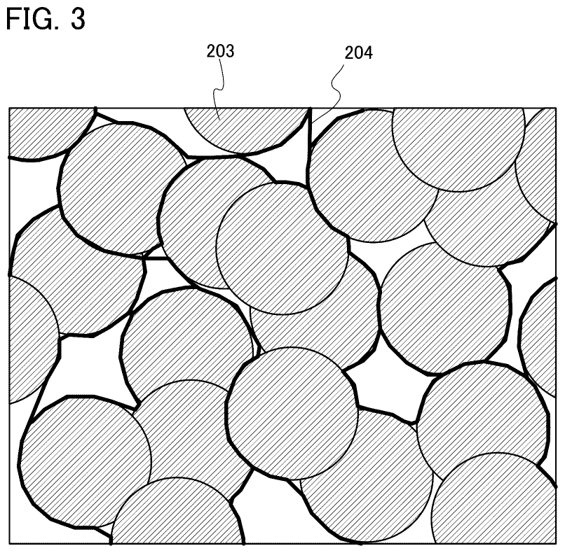

In this embodiment, a storage battery electrode of one embodiment of the present invention will be described with reference to FIGS. 2A to 2C and FIG. 3. FIG. 2A is a perspective view of the electrode, FIG. 2B is a plan view of an active material layer, and FIG. 2C and FIG. 3 are each a longitudinal cross-sectional view of the active material layer.

FIG. 2A is a perspective view of an electrode 200. Although the electrode 200 in the shape of a rectangular sheet is illustrated in FIG. 2A, the shape of the electrode 200 is not limited thereto and may be any appropriate shape. An active material layer 202 is formed on only one side of a current collector 201 in FIG. 2A; however, the active material layer 202 may be formed on both sides of the current collector 201. The active material layer 202 does not necessarily need to be formed over the entire surface of the current collector 201 and a region that is not coated, such as a region for connection to a tab, is provided as appropriate.

The positive electrode current collector 201 can be formed using a highly conductive material that is not alloyed with a carrier ion of lithium or the like, for example, a metal such as stainless steel, gold, platinum, zinc, iron, copper, aluminum, and titanium or an alloy thereof. Alternatively, an aluminum alloy to which an element which improves heat resistance, such as silicon, titanium, neodymium, scandium, and molybdenum, is added can be used. Further alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The current collector 201 can have a foil-like shape, a plate-like shape (sheet-like shape), a net-like shape, a punching-metal shape, an expanded-metal shape, or the like as appropriate. The current collector 201 preferably has a thickness greater than or equal to 10 μm and less than or equal to 30 μm. A surface of the current collector 201 may be provided with an undercoat layer using graphite or the like.

FIGS. 2B and 2C are a schematic top view and a schematic longitudinal cross-sectional view of the active material layer 202. The active material layer 202 contains graphene 204 as a conductive additive, active material particles 203, and a binder (not illustrated). The active material layer 202 may contain a conductive additive (not illustrated, also referred to as a second conductive additive) other than graphene.

As in the active material layer 202 illustrated in the top view in FIG. 2B, the active material particles 203 are coated with a plurality of sheets of the graphene 204. Each sheet of the graphene 204 is connected to a plurality of the active material particles 203. In particular, since the graphene 204 is in the form of a sheet, surface contact can be made so as to cover part of the surfaces of the active material particles 203. Unlike a conductive additive in the form of particles, such as acetylene black, which makes point contact with an active material, the graphene 204 is capable of surface contact with low contact resistance; accordingly, the electron conductivity of the active material particles 203 and the graphene 204 can be improved without increasing the amount of conductive additive.

Furthermore, surface contact is made between a plurality of sheets of the graphene 204. This is because graphene oxide with extremely high dispersibility in a polar solvent is used for formation of the graphene 204. A solvent is removed by evaporation from a mixture in which graphene oxide is uniformly dispersed, and the graphene oxide is reduced to graphene; hence, the sheets of the graphene 204 remaining in the active material layer 202 partly overlap with each other and are dispersed such that surface contact is made. Accordingly, an electric conduction path is formed in the active material layer 202.

In the top view of the active material layer 202 in FIG. 2B, the graphene 204 does not necessarily overlap with another graphene on a surface of the active material layer 202; part of the graphene 204 is provided between the active material layers 202. The graphene 204 is an extremely thin film (sheet) made of a single layer or stacked layers of carbon molecules and thus is in contact with part of the surfaces of the active material particles 203 so as to trace these surfaces. A portion of the graphene 204 that is not in contact with the active material particles 203 is warped between the active material particles 203 and crimped or stretched.

The longitudinal section of the active material layer 202 in FIG. 2C shows substantially uniform dispersion of the sheet-like graphene 204 in the active material layer 202. The graphene 204 is schematically shown by a heavy line in FIG. 2C but is actually a thin film having a thickness corresponding to the thickness of a single layer or a multiple layer of carbon molecules. As described using the top view of the active material layer 202, a plurality of sheets of the graphene 204 are formed so as to wrap or coat a plurality of the active material particles 203 and thus are in surface contact with the active material particles 203. Furthermore, a plurality of sheets of the graphene 204 are also in surface contact with each other; consequently, a plurality of sheets of the graphene 204 construct an electric conduction network. FIG. 3 is a schematic enlarged view of FIG. 2C. The graphene 204 coats the surfaces of a plurality of the active material particles 203 so as to cling to the surfaces, and a plurality of sheets of graphene are also in contact with each other; thus, the network is constructed.

As illustrated in FIG. 2B, FIG. 2C, and FIG. 3, a plurality of sheets of the graphene 204 are three-dimensionally dispersed throughout the active material layer 202 and in surface contact with each other, which constructs the three-dimensional electric conduction network. Furthermore, each sheet of the graphene 204 coats and makes surface contact with a plurality of the active material particles 203.

In a manufacturing method of a storage battery electrode to be described in Embodiment 2, the graphene 204 is formed by reduction of graphene oxide with a reducing agent. Since the reducing agent is used in formation of the active material layer 202 in the manufacturing method of a storage battery electrode, the reducing agent may remain in the active material layer 202. The reducing agent is oxidized at the time when the graphene oxide is reduced. Thus, the active material layer 202 may include a derivative generated when the reducing agent is oxidized (hereinafter, the derivative is called an oxidized derivative of a reducing agent).

The reducing agent or the oxidized derivative of the reducing agent in the active material layer 202 can be detected by an analytical method such as energy dispersive X-ray spectrometry (EDX), X-ray photoelectron spectroscopy (XPS), or time-of-flight secondary ion mass spectrometry (ToF-SIMS).

Examples of the reducing agent include ascorbic acid, hydrazine, dimethyl hydrazine, hydroquinone, sodium tetrahydroborate (NaBH₄), lithium aluminum hydride (LiAlH₄), N,N-diethylhydroxylamine, and a derivative thereof. In particular, ascorbic acid and hydroquinone are preferable to hydrazine and NaBH₄ in that they are safe due to low reducing ability and utilized industrially with ease.

The reduction reaction of the graphene oxide makes the reducing agent to be the oxidized derivative of the reducing agent. Here, a redox reaction of ascorbic acid is described as an example. Ascorbic acid becomes dehydroascorbic acid when oxidized. Thus, in the case of using ascorbic acid as the reducing agent, dehydroascorbic acid may remain in the active material layer 202 as the oxidized derivative of the reducing agent. Even when a reducing agent other than ascorbic acid is used, the oxidized derivative of the reducing agent may remain in the active material layer 202.

Graphene is a carbon material having a crystal structure in which hexagonal skeletons of carbon are spread in a planar form and is one atomic plane extracted from graphite crystals. Due to its surprisingly excellent electrical, mechanical, or chemical characteristics, graphene has been expected to be used for a variety of fields of, for example, field-effect transistors with high mobility, highly sensitive sensors, highly-efficient solar cells, and next-generation transparent conductive films, and has attracted a great deal of attention.

Note that graphene in this specification refers to single-layer graphene or multilayer graphene including two or more and hundred or less layers. Single-layer graphene refers to a one-atom-thick sheet of carbon molecules having x bonds. Graphene oxide refers to a compound formed by oxidation of such graphene. When graphene oxide is reduced to give graphene, oxygen contained in the graphene oxide is not entirely released and part of the oxygen may remain in graphene. With the manufacturing method of a storage battery electrode to be described in Embodiment 2, the reduction efficiency of the graphene oxide can be increased. In the case where graphene contains oxygen, the proportion of oxygen in the graphene, which is measured by XPS, is higher than or equal to 2 atomic % and lower than or equal to 20 atomic %, and preferably higher than or equal to 3 atomic % and lower than or equal to 10 atomic %. As described above, a plurality of sheets of the graphene 204 are three-dimensionally dispersed throughout the active material layer 202 and in surface contact with each other, which constructs the three-dimensional electric conduction network. The reduction efficiency of the graphene oxide can be thus increased, leading to lower internal impedance of the active material layer 202 and the electrode 200.

Graphene oxide can be formed by an oxidation method called a Hummers method. In the Hummers method, a sulfuric acid solution of potassium permanganate, a hydrogen peroxide solution, and the like are mixed into graphite powder to cause an oxidation reaction; thus, a mixed solution containing graphite oxide is formed. Through the oxidation of carbon of graphite, functional groups such as epoxy groups, carbonyl groups, carboxyl groups, or hydroxyl groups are bonded in graphite oxide. Accordingly, the interlayer distance between a plurality of sheets of graphene in graphite oxide becomes longer than the interlayer distance in graphite, so that graphite oxide can be easily separated into thin pieces by interlayer separation. Then, ultrasonic vibration is applied to the mixed solution containing graphite oxide, so that graphite oxide whose interlayer distance is long can be cleaved to separate graphene oxide and to form a mixed solution containing graphene oxide. A solvent is removed from the mixed solution containing graphene oxide, so that powdery graphene oxide can be obtained.

The graphene oxide may be formed by adjusting the amount of an oxidizing agent such as potassium permanganate as appropriate. When the amount of the oxidizing agent with respect to the graphite powder is increased, for example, the degree of oxidation of the graphene oxide (the atomic ratio of oxygen to carbon) can be increased. The amount of the oxidizing agent with respect to the graphite powder, which is a raw material, can be determined depending on the amount of graphene oxide to be manufactured.

Note that the method for forming graphene oxide is not limited to the Hummers method using a sulfuric acid solution of potassium permanganate; for example, the Hummers method using nitric acid, potassium chlorate, nitric acid sodium, or the like or a method for forming graphene oxide other than the Hummers method may be employed as appropriate.

Graphite oxide may be separated into thin pieces by application of ultrasonic vibration, by irradiation with microwaves, radio waves, or thermal plasma, or by application of physical stress.

The formed graphene oxide includes an epoxy group, a carbonyl group, a carboxyl group, a hydroxyl group, or the like. In a polar solvent, oxygen in such a functional group is negatively charged; thus, the graphene oxide interacts with the polar solvent. Meanwhile, different sheets of graphene oxide repel each other and thus are less likely to be aggregated. For this reason, the graphene oxide is easily dispersed uniformly throughout the polar solvent.

The length of one side (also referred to as a flake size) of the graphene oxide is greater than or equal to 50 nm and less than or equal to 100 μm, and preferably greater than or equal to 800 nm and less than or equal to 20 μm. The flake size of graphene in the active material layer can be adjusted by adjusting the flake size of the graphene oxide. When the flake size of the graphene is larger than the average particle size of the active material particles 203, the surface contact between the graphene and a plurality of the active material particles 203 and connection between the sheets of graphene become easy, which is effective in improving the electrical conductivity of the active material layer 202.

The active material particles 203 are made of secondary particles having an average diameter or a particle diameter distribution, which are obtained in such a way that material compounds are mixed at a predetermined ratio and baked and the resulting baked product is crushed, granulated, and classified by an appropriate means. Therefore, the shape of each of the active material particles 203 is not limited to such a spherical shape as is schematically illustrated in FIGS. 2B and 2C.

In the case of using the electrode 200 as a positive electrode of a storage battery, a material into and from which lithium ions can be inserted and extracted can be used for the active material particles 203. For example, a lithium-manganese composite oxide with an olivine crystal structure, a layered rock-salt crystal structure, or a spinel crystal structure can be used.

As an example of a lithium-containing complex phosphate with an olivine crystal structure, a composite phosphate represented by a general formula LiMPO₄ (M is one or more of Fe(II), Mn(II), Co(II), and Ni(II)) can be given. Typical examples of the general formula LiMPO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCO_{b}PO₄, LiNiₐMn_{b}PO₄ (a+b≤1, 0<a<1, and 0<b<1), Life_{c}Ni_{d}CoₑPO₄, Life_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

LiFePO₄ is particularly preferable because it properly has properties necessary for the active material, such as safety, stability, high capacity density, high potential, and the existence of lithium ions that can be extracted in initial oxidation (charging).

Examples of a lithium-containing complex silicate with a layered rock-salt crystal structure include LiCoO₂, LiNiO₂, LiMnO₂, Li₂MnO₃, a NiCo-based compound such as LiNi_{0.8}Co_{0.2}O₂ (general formula: LiNiₓCo₁₋ₓO₂ (0<x <1)), a NiMn-based compound such as LiNi_{0.5}Mn_{0.5}O₂ (general formula: LiNiₓMn₁₋₁O₂ (0<x<1)), a NiMnCo-based compound such as LiNi1/3Mn1/3Co1/3O2 (also referred to as NMC, general formula: LiNiₓMn_{y}Co_{1-1-y}O₂ (x>0, y>0, x+y<1), Li(Ni_{0.8}Co_{0.15}Al_{0.05})O₂, and Li₂MnO₃—LiMO₂ (M=Co, Ni, or Mn).

LiCoO₂ is particularly preferable because of its high capacity, and its stability in the air and thermal stability higher than those of LiNiO₂.

Examples of a lithium-manganese composite oxide with a spinel crystal structure include LiMn₂O₄, Li₁₊ₓMn₂₋ₓO₄ (0<x<2), LiMn₂₋ₓAlₓO₄ (0<x<2), and LiMn_{1.5}Ni_{0.5}O₄.

It is preferable to add a small amount of lithium nickel oxide (LiNiO₂ or LiNi₁₋ₓMₓO₂ (0<x<1, M=Co, Al, or the like)) to the lithium-manganese composite oxide with a spinel crystal structure such as LiMn₂O₄, in which case the dissolution of manganese and the decomposition of an electrolyte solution can be suppressed, for example.

A composite oxide represented by a general formula Li₍₂₋ⱼ₎MSiO₄ (M is one or more of Fe(II), Mn(II), Co(II), and Ni(II), 0≤j≤2) can also be used as the positive electrode active material. Typical examples of the general formula Li₍₂₋ⱼ₎MSiO₄ include Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≤1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≤1, 0<m<1, 0<n<1, and 0<q<1), and Li₍₂₋ⱼ₎FeᵣNiₛCoₜMnᵤSiO₄ (r+s+t+u≤1, 0<r<1, 0<s<1, 0<t<1, and 0<u<1).

A nasicon compound represented by a general formula AₓM₂(XO₄)₃ (A=Li, Na, or Mg, M=Fe, Mn, Ti, V, Nb, or Al, and X=S, P, Mo, W, As, or Si) can also be used as the positive electrode active material. Examples of the nasicon compound include Fe₂(MnO₄)₃, Fe₂(SO₄)₃, and Li₃Fe₂(PO₄)₃. Alternatively, a compound represented by a general formula Li₂MPO₄F, Li₂MP₂O₇, or Li₅MO₄ (M=Fe or Mn), a perovskite fluoride such as FeF₃, a metal chalcogenide (a sulfide, a selenide, or a telluride) such as TiS₂ or MoS₂, a lithium-vanadium-containing composite oxide with an inverse spinel structure such as LiMVO₄, a vanadium oxide-based compound (such as V₂O₅, V₆O₁₃, or LiV₃O₈), a manganese oxide, an organic sulfur compound, or the like can be used as the positive electrode active material.

The particle diameter of the positive electrode active material is preferably, for example, greater than or equal to 5 nm and less than or equal to 100 μm.

As the positive electrode active material, a lithium-manganese composite oxide that is represented by a composition formula LiₓMn_{y}M_{z}O_{w} can also be used. Here, the element M is preferably silicon, phosphorus, or a metal element other than lithium and manganese, and further preferably nickel. Note that it is preferable to satisfy 0□x/(y+z)<2, 0<z, and 0.26□(y+z)/w<0.5. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like. The lithium-manganese composite oxide preferably has a layered rock-salt crystal structure. The lithium-manganese composite oxide may have a layered rock-salt crystal structure and a spinel crystal structure. The average particle diameter of the lithium-manganese composite oxide is preferably greater than or equal to 5 nm and less than or equal to 50 μm, for example.

In the case where carrier ions are alkali metal ions other than lithium ions, or alkaline-earth metal ions, the positive electrode active material may contain, instead of lithium in the lithium compound or the lithium-manganese composite oxide, an alkali metal (e.g., sodium or potassium) or an alkaline-earth metal (e.g., calcium, strontium, barium, beryllium, or magnesium).

In the case where the storage battery electrode to be manufactured is used as a negative electrode of a storage battery, a material that enables charge-discharge reactions by an alloying reaction and a dealloying reaction with lithium can be used as the active material particles 203.

As the material that enables charge-discharge reactions by an alloying reaction and a dealloying reaction with lithium, a carbon-based material can be given. Examples of the carbon-based material include graphite, graphitizing carbon (soft carbon), non-graphitizing carbon (hard carbon), a carbon nanotube, graphene, and carbon black.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (higher than or equal to 0.1 V and lower than or equal to 0.3 V vs. Li/Li⁺) when lithium ions are inserted into the graphite (while a lithium-graphite intercalation compound is formed). For this reason, a lithium-ion secondary battery can have a high operating voltage. Graphite is preferable also because of its advantages such as relatively high capacity per unit volume, small volume expansion, low cost, and safety greater than that of a lithium metal.

As the material that enables charge-discharge reactions by an alloying reaction and a dealloying reaction with lithium, a material containing at least one of Ga, Si, Al, Ge, Sn, Pb, Sb, Bi, Ag, Zn, Cd, In, and the like can also be used, for example. Such elements have higher capacity than carbon. In particular, silicon has a high theoretical capacity of 4200 mAh/g. Examples of the material containing such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

As the negative electrode active material, an oxide such as SiO, SnO, SnO₂, titanium dioxide, a lithium titanium oxide, a lithium-graphite intercalation compound, niobium pentoxide, tungsten oxide, or molybdenum oxide can be used.

As the negative electrode active material, Li₃₋ₓMₓN (M=Co, Ni, or Cu) with a Li₃N structure, which is a nitride containing lithium and a transition metal, can also be used. A lithium-ion secondary battery containing Li_{2.6}Co_{0.4}N, for example, is preferable because of its high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for the positive electrode active material which does not contain lithium ions, such as V₂O₅ or Cr₃O₈. In the case of using a material containing lithium ions as the positive electrode active material, the nitride containing lithium and a transition metal can be used as the negative electrode active material as long as the lithium ions contained in the positive electrode active material are extracted in advance.

A material which causes a conversion reaction can also be used as the negative electrode active material; for example, a transition metal oxide which does not cause an alloy reaction with lithium, such as cobalt oxide (CoO), nickel oxide (NiO), or iron oxide (FeO), may be used. An oxide such as Fe₂O₃, CuO, Cu₂O, RuO₂, or Cr₂O₃, a sulfide such as CoS_{0.89}, NiS, or CuS, a nitride such as Zn₃N₂, Cu₃N, or Ge₃N₄, a phosphide such as NiP₂, FeP₂, or CoP₃, or a fluoride such as FeF₃ or BiF₃ can also be used as the material which causes a conversion reaction.

The average particle diameter of the primary particles of the active material particles 203, when measured using a laser diffraction particle size analyzer, for example, is preferably less than or equal to 500 nm, and further preferably greater than or equal to 50 nm and less than or equal to 500 nm. To make surface contact with a plurality of the active material particles 203, the graphene 204 has sides the length of each of which is preferably greater than or equal to 50 nm and less than or equal to 100 μm, and further preferably greater than or equal to 800 nm and less than or equal to 20 μm.

As the binder in the active material layer 202, polyvinylidene fluoride (PVdF) is used typically, and polyimide, polytetrafluoroethylene, polyvinyl chloride, an ethylene-propylene-diene polymer, styrene-butadiene rubber, acrylonitrile-butadiene rubber, fluorine rubber, polyvinyl acetate, polymethyl methacrylate, polyethylene, nitrocellulose, or the like can be used.

The active material layer 202 may contain the second conductive additive. In the case where the active material layer 202 contains graphene and the second conductive additive, the three-dimensional electric conduction network in the active material layer can be more complicated. In that case, an electric conduction path in the active material layer 202 can be prevented from being cut while the power storage device is used. For the second conductive additive, natural graphite, artificial graphite such as meso-carbon microbeads, or carbon fiber can be used. Alternatively, metal powder or metal fiber of copper, nickel, aluminum, silver, gold, or the like, a conductive ceramic material, or the like can be used.

Examples of carbon fiber include mesophase pitch-based carbon fiber, isotropic pitch-based carbon fiber, carbon nanofiber, carbon nanotube, and vapor-grown carbon fiber (VGCF, registered trademark). The representative values of VGCF (registered trademark) are as follows: the fiber diameter is 150 nm; the fiber length is greater than or equal to 10 μm and less than or equal to 20 μm; the real density is 2 g/cm³; and the specific surface area is 13 m²/g. Note that the fiber diameter is, when a cross section perpendicular to a fiber axis is regarded as a cutting plane in a two-dimensional image obtained with a scanning electron microscope (SEM), a diameter of a perfect circle that circumscribes the cutting plane. The real density is a density calculated using a volume occupied by a substance itself. The specific surface area is the surface area of an object per unit mass or per unit volume.

Note that needle-like VGCF (registered trademark) has an excellent electrical characteristic of high conductivity and an excellent physical property of high mechanical strength. For this reason, the use of VGCF (registered trademark) as the conductive additive can increase the points and the area where the active materials are in contact with each other.

Alternatively, a particle-like material can be used for the conductive additive. A typical example of the particle-like material is carbon black, such as acetylene black or ketjen black (registered trademark), whose diameter is greater than or equal to 3 nm and less than or equal to 500 nm.

A flake-like, needle-like, or fiber-like conductive additive has a function of binding the active materials and inhibits deterioration of a battery. Such a conductive additive also functions as a structure body for maintaining the shape of the active material layer 202 or cushioning. Thus, separation between the current collector and the active materials is less likely to occur even when a secondary battery is changed in its form by being bent or by repeated expansion and contraction of the active materials. Although carbon black such as acetylene black or ketjen black (registered trademark) may be used instead of the above material, VGCF (registered trademark) is preferably used because the strength for keeping the shape of the active material layer 202 can be increased. When the strength for keeping the shape of the active material layer 202 is high, deterioration of the secondary battery caused by changes in its form (e.g., bending) can be prevented.

The above-described active material layer 202 preferably contains, with respect to the total weight of the active material layer 202, the active material particles 203 at greater than or equal to 80 wt % and less than or equal to 95 wt %, the graphene at greater than or equal to 0.1 wt % and less than or equal to 8 wt %, and the binder at greater than or equal to 1 wt % and less than or equal to 10 wt %. In the case where the active material layer 202 contains the second conductive additive, the sum of the weight ratio of the graphene and the weight ratio of the second conductive additive is preferably greater than or equal to 0.1 wt % and less than or equal to 8 wt % with respect to the total weight of the active material layer 202.

As described in this embodiment, the sheets of the graphene 204 larger than the average particle diameter of the active material particles 203 are dispersed throughout the active material layer 202 such that one sheet of the graphene 204 makes surface contact with one or more adjacent sheets of the graphene 204, and the sheets of the graphene 204 make surface contact so as to wrap part of the surfaces of the active material particles 203. Consequently, with a small amount of a conductive additive, a storage battery electrode including a high-density active material layer which is highly filled can be provided.

In Embodiment 1, one embodiment of the present invention has been described. Other embodiments of the present invention are described in Embodiments 2 to 7. Note that one embodiment of the present invention is not limited thereto. That is, various embodiments of the invention are described in Embodiments 1 to 7, and thus one embodiment of the present invention is not limited to a specific embodiment. Although the case where graphene is used for a storage battery electrode is described as an example of one embodiment of the present invention, one embodiment of the present invention is not limited to the case. Depending on circumstances or conditions, graphene or graphene oxide can be used for any of the following components: an electrode for a supercapacitor that has extremely high capacitance; an oxygen-reduction electrode catalyst; a material of a dispersion liquid with lower friction than a lubricant; a transparent electrode for a display device or a solar battery; a gas-barrier material; a polymer material with high mechanical strength and lightweight; a material for a sensitive nanosensor for sensing uranium or plutonium contained in radiation-tainted water; and a material used for removing a radioactive material. Depending on circumstances or conditions, for example, graphene is not necessarily used for the storage battery electrode in one embodiment of the present invention.

This embodiment can be implemented in combination with any of the other embodiments as appropriate.

### Embodiment 2

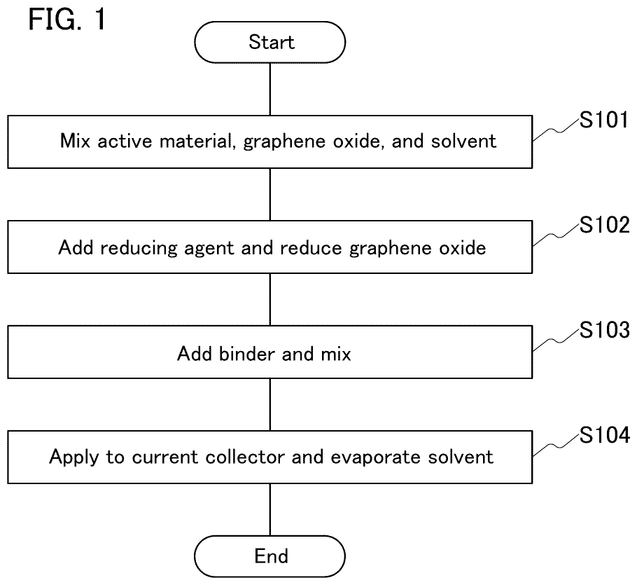

In this embodiment, a method for manufacturing the electrode 200 including the active material layer 202 by using the active material, the conductive additive, and the binder that are described in Embodiment 1 as examples will be described with reference to FIG. 1.

First, an active material, graphene oxide, and a solvent are mixed to form a first mixture (Step S101). A second conductive additive may be added to the first mixture. For the active material, the graphene oxide, and the second conductive additive, any of the materials described in Embodiment 1 can be used.

A polar solvent can be used as the solvent for forming the mixture. For example, a polar solvent containing one of methanol, ethanol, acetone, tetrahydrofuran (THF), dimethylformamide (DMF), N-methylpyrrolidone (NMP), and dimethyl sulfoxide (DMSO) or a mixed solution of two or more of the above can be used. It is particularly preferable to use NMP because graphene oxide can be well dispersed therein.

Next, the first mixture is kneaded (mixed in a highly viscous state), so that the cohesion of the graphene oxide and the active material can be weakened. Since oxygen in a functional group of the graphene oxide is negatively charged in the polar solvent, different sheets of graphene oxide are unlikely to be aggregated. Hence, the active material and the graphene oxide can be further uniformly dispersed.

After that, a reducing agent is added to the first mixture and they are mixed to reduce the graphene oxide, whereby a second mixture is formed (Step S102). It is preferable that the reducing agent dissolved in a small amount of a solvent be added to the first mixture, which leads to easy mixing. Through this step, the graphene oxide can be reduced to be graphene. Note that oxygen in the graphene oxide is not necessarily entirely released and may partly remain in the graphene.

For the reducing agent, any of the materials described in Embodiment 1 can be used.

As the solvent in which the reducing agent is dissolved, a low-boiling solvent in which the reducing agent is easily dissolved can be used. For example, water, methanol, ethanol, or the like can be used.

The mixture to which the reducing agent is added may be heated at a temperature higher than or equal to 30 □C and lower than or equal to 200 □C, preferably higher than or equal to 50 □C and lower than or equal to 100 □C. The heating can promote the reduction reaction of the graphene oxide. There is no particular limitation on the atmosphere.

The graphene oxide can also be reduced not by addition of the reducing agent, but by heating of the mixture containing the graphene oxide. Note that the heating needs to be performed at high temperatures to reduce the graphene oxide sufficiently. However, the limitation such as heat resistant temperature of a material or an apparatus used for manufacturing the electrode might inhibit sufficient heating of the graphene oxide, resulting in insufficient reduction. In contrast, one embodiment of the present invention does not require heating at high temperatures; the graphene oxide can be reduced by addition of the reducing agent. Thus, Step S102 can be considered to increase the reduction efficiency of the graphene oxide under mild conditions.

The proportion of the weight of the reducing agent to the weight of the graphene oxide contained in the first mixture is preferably set higher than or equal to 5 wt % and lower than or equal to 500 wt %. The weight of the reducing agent may be changed depending on the degree of oxidation of the graphene oxide used in Step S101.

The use of a high density active material might increase the density of the active material layer 202. Examples of the high density active material include a lithium-manganese composite oxide represented by the composition formula LiₓMn_{y}M_{z}O_{w}, LiCoO₂, and a NiMnCo-based material such as LiNi_{1/3}Mn_{1/3}Co_{1/3}O₂. In the case where the graphene oxide is reduced after the active material layer 202 is formed, the graphene oxide cannot be reduced sufficiently in some cases. This is probably because the active material layer 202 hardly contains air gaps and the reducing agent does not sufficiently penetrate deeply into the active material.

As shown in Step S102, in one embodiment of the present invention, the reducing agent is added to the first mixture, which is the predecessor of the active material layer, so that the graphene oxide is reduced. When the reducing agent is added to the first mixture, the reducing agent is widely dispersed throughout the mixture and the graphene oxide contained in the second mixture can be reduced with high efficiency. Accordingly, the active material layer 202 in which the graphene oxide is reduced with high efficiency can be formed in Step S104 performed later.

Furthermore, in comparison with the case where the graphene oxide is reduced after the electrode is completed, a large amount of graphene oxide can be reduced at a time in some cases where the reducing agent is added to the first mixture for the reduction of the graphene oxide. This suggests that one embodiment of the present invention allows simplification of a process and improvement in mass productivity.

When a basic active material is used as the active material, the second mixture might be basic. In that case, PVdF, which is added to the second mixture in the subsequent Step S103, might be gelled; as a result, uniform mixing of a third mixture might be difficult. However, even when a basic active material is used as the active material, addition of acid as the reducing agent in Step S102 can prevent the second mixture from being strongly basic. In that case, PVdF can be prevented from being gelled in the subsequent Step S103; thus, mixing of the third mixture can be performed uniformly. Since the active material layer in which the binder is uniformly dispersed can be formed as a result of the above, an electrode with a uniform thickness can be manufactured. Furthermore, an electrode with high strength, for example, an electrode hardly damaged by the external impact, can be manufactured.

Examples of the basic active material include a lithium-manganese composite oxide represented by the composition formula LiₓMn_{y}M_{z}O_{w}.

Examples of the acid that can be used as the reducing agent include ascorbic acid and hydroquinone.

In the case of using an active material or a binder that is unstable to acid, a base is preferably used as the reducing agent in Step S102. Examples of the active material unstable to acid include LiCoO₂ and LiFePO₄. Examples of the binder unstable to acid include SBR. Examples of the base that can be used as the reducing agent include hydrazine, dimethyl hydrazine, sodium tetrahydroborate, and N,N-diethylhydroxylamine.

As described above, with the use of acid as the reducing agent in one embodiment of the present invention, a basic active material and a binder that is gelled in a strongly basic mixture can be used in combination to manufacture an electrode with a uniform thickness or an electrode with high strength. With the use of a base as the reducing agent, an electrode can be manufactured by using an active material or a binder that is unstable to acid. One embodiment of the present invention is preferable because the range of choices for materials of an active material and a binder and for combinations of the materials can be wide.

The second mixture may be heated at a temperature higher than or equal to 20 □C and lower than or equal to 80 □C in a reduced pressure atmosphere for 5 minutes or more and 10 hours or less to remove the solvent added when the reducing agent is added.

Next, a binder is added to the second mixture and kneading is performed, so that the third mixture (paste) is formed (Step S103). For the binder, any of the materials described in Embodiment 1 can be used.

Then, the third mixture is applied to a current collector and the solvent is evaporated, so that an active material layer is formed (Step S104). Specifically, the third mixture and the current collector are heated at a temperature higher than or equal to 20 □C and lower than or equal to 170 □C for 1 minute or more and 10 hours or less to evaporate the solvent contained in the third mixture, whereby the active material layer can be formed. Note that there is no particular limitation on the atmosphere.

Through the above steps, the electrode 200 including the active material layer 202 where a plurality of sheets of the graphene 204 and the active material particles 203 are uniformly dispersed can be manufactured. After that, a step of applying pressure to the electrode 200 may be performed.

As described in this embodiment, the reducing agent is added to the first mixture containing the active material, the graphene oxide, and the solvent and then the heating is performed, so that the graphene oxide can be reduced under mild conditions and the reduction efficiency of the graphene oxide can be increased. Then, the third mixture is formed using the second mixture containing graphene and is applied to the current collector, followed by evaporation of the solvent; thus, an electrode containing graphene as a conductive additive can be manufactured under mild conditions. Furthermore, an electrode with a uniform thickness can be manufactured. In addition, an electrode with high strength that is hardly damaged by the external impact can be manufactured. Thus, when a storage battery is manufactured using the manufacturing method of an electrode described in this embodiment, cycle characteristics and rate characteristics of the storage battery can be improved. Furthermore, a manufacturing method of a storage battery can be simplified. In addition, a storage battery with high strength, for example, a storage battery hardly damaged by the external impact, can be manufactured.

This embodiment can be implemented in combination with any of the other embodiments as appropriate.

### Embodiment 3

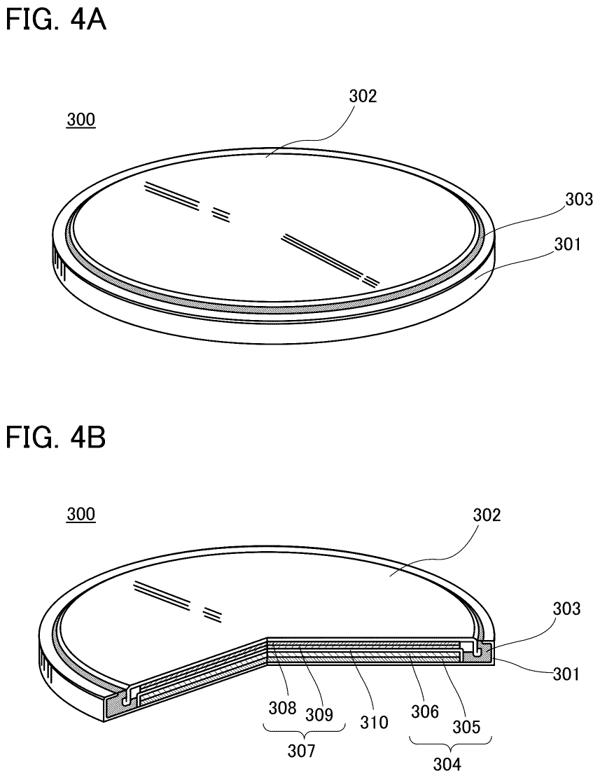

In this embodiment, the structure of a storage battery including a storage battery electrode manufactured by the manufacturing method described in Embodiment 2 will be described with reference to FIGS. 4A and 4B, FIG. 5, FIGS. 6A and 6B, and FIGS. 7A and 7B.

### Coin-Type Storage Battery

FIG. 4A is an external view of a coin-type (single-layer flat type) storage battery, and FIG. 4B is a cross-sectional view thereof.

In a coin-type storage battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. A separator 310 and an electrolytic solution (not illustrated) are provided between the positive electrode active material layer 306 and the negative electrode active material layer 309.

At least one of the positive electrode 304 and the negative electrode 307 can be manufactured by the manufacturing method of a storage battery electrode of one embodiment of the present invention, which is described in Embodiment 2.

Described is the structure of the positive electrode active material layer 306 or the negative electrode active material layer 309 in the case where the manufacturing method of a storage battery electrode described in Embodiment 2 is not used for one of the positive electrode 304 and the negative electrode 307.

The positive electrode active material layer 306 may further include a binder for increasing adhesion of positive electrode active materials, a conductive additive for increasing the conductivity of the positive electrode active material layer 306, and the like in addition to the positive electrode active materials.

For the positive electrode active material, the binder, and the conductive additive, any of the materials described in Embodiment 1 can be used.

The negative electrode active material layer 309 may further include a binder for increasing adhesion of the negative electrode active material, a conductive additive for increasing the conductivity of the negative electrode active material layer 309, and the like in addition to the above negative electrode active material.

For the negative electrode active material, the binder, and the conductive additive, any of the materials described in Embodiment 1 can be used.

Furthermore, a coating film of oxide or the like may be formed on the surface of the negative electrode active material layer 309. A coating film formed by decomposition of an electrolytic solution or the like in charging cannot release electric charges used at the time of forming the coating film, and therefore forms irreversible capacity. In contrast, the coating film of oxide or the like provided on the surface of the negative electrode active material layer 309 in advance can reduce or prevent generation of irreversible capacity.

As the coating film covering the negative electrode active material layer 309, an oxide film of any one of niobium, titanium, vanadium, tantalum, tungsten, zirconium, molybdenum, hafnium, chromium, aluminum, and silicon or an oxide film containing any one of these elements and lithium can be used. The coating film is much denser than a conventional film formed on a surface of a negative electrode due to a decomposition product of an electrolytic solution.

For example, niobium pentoxide (Nb₂O₅) has a low electric conductivity of 10⁻⁹ S/cm and a high insulating property. For this reason, a niobium oxide film inhibits an electrochemical decomposition reaction of the electrolyte solution or the like which is caused by contact between the negative electrode active material and the electrolyte solution in charging. On the other hand, niobium oxide has a lithium diffusion coefficient of 10⁻⁹ cm²/sec and high lithium ion conductivity. Therefore, niobium oxide can transmit lithium ions. Alternatively, silicon oxide or aluminum oxide may be used.

A sol-gel method can be used to coat the negative electrode active material layer 309 with the coating film, for example. The sol-gel method is a method for forming a thin film in such a manner that a solution of metal alkoxide, a metal salt, or the like is changed into a gel, which has lost its fluidity, by a hydrolysis reaction or a polycondensation reaction and the gel is baked. Since a thin film is formed from a liquid phase in the sol-gel method, raw materials can be mixed uniformly on the molecular scale. For this reason, by adding a negative electrode active material such as graphite to a raw material of the metal oxide film which is a solution, the active material can be easily dispersed into the gel. In such a manner, the coating film can be formed on the surface of the negative electrode active material layer 309. A decrease in the capacity of the power storage unit can be prevented by using the coating film.

As the separator 310, an insulator including pores, such as cellulose (paper), polyethylene, or polypropylene can be used.

As an electrolyte solution, as well as an electrolytic solution containing a supporting electrolyte, a solid electrolyte or a gel electrolyte obtained by gelation of part of an electrolytic solution can be used.

As a supporting electrolyte, a material which contains carrier ions can be used. Typical examples of the supporting electrolyte are lithium salts such as LiPF₆, LiClO₄, LiAsF₆, LiBF₄, LiCF₃SO₃, Li(CF₃SO₂)₂N, and Li(C₂F₅SO₂)₂N. One of these electrolytes may be used alone or two or more of them may be used in an appropriate combination and in an appropriate ratio.

Note that when carrier ions are alkali metal ions other than lithium ions or alkaline-earth metal ions, instead of lithium in the above lithium salts, an alkali metal (e.g., sodium or potassium), an alkaline-earth metal (e.g., calcium, strontium, barium, beryllium, or magnesium) may be used for the electrolyte.

As a solvent of the electrolytic solution, a material in which carrier ions can move can be used. As the solvent of the electrolytic solution, an aprotic organic solvent is preferably used. Typical examples of aprotic organic solvents include ethylene carbonate (EC), propylene carbonate, dimethyl carbonate, diethyl carbonate (DEC), γ-butyrolactone, acetonitrile, dimethoxyethane, tetrahydrofuran, and the like, and one or more of these materials can be used. When a gelled high-molecular material is used as the solvent of the electrolytic solution, safety against liquid leakage and the like is improved. Further, the storage battery can be thinner and more lightweight. Typical examples of gelled high-molecular materials include a silicone gel, an acrylic gel, an acrylonitrile gel, polyethylene oxide-based gel, polypropylene oxide-based gel, a fluorine-based polymer gel, and the like. Alternatively, the use of one or more of ionic liquids (particularly, room temperature molten salts) which have features of non-flammability and non-volatility as a solvent of the electrolytic solution can prevent the storage battery from exploding or catching fire even when the storage battery internally shorts out or the internal temperature increases owing to overcharging or the like. An ionic liquid contains a cation and an anion. Examples of an organic cation included in an ionic liquid include aliphatic onium cations such as a quaternary ammonium cation, a tertiary sulfonium cation, and a quaternary phosphonium cation, and aromatic cations such as an imidazolium cation and a pyridinium cation. Examples of the anion included in the ionic liquid include a monovalent amide-based anion, a monovalent methide-based anion, a fluorosulfonate anion, a perfluoroalkylsulfonate anion, tetrafluoroborate, perfluoroalkylborate, hexafluorophosphate, and perfluoroalkylphosphate.

Instead of the electrolytic solution, a solid electrolyte including an inorganic material such as a sulfide-based inorganic material or an oxide-based inorganic material, or a solid electrolyte including a high-molecular material such as a polyethylene oxide (PEO)-based high-molecular material may alternatively be used. When the solid electrolyte is used, a separator or a spacer is not necessary. Further, the battery can be entirely solidified; therefore, there is no possibility of liquid leakage and thus the safety of the battery is dramatically increased.

For the positive electrode can 301 and the negative electrode can 302, a metal having a corrosion-resistant property to a liquid such as an electrolytic solution in charging and discharging a secondary battery, such as nickel, aluminum, or titanium; an alloy of any of the metals; an alloy containing any of the metals and another metal (e.g., stainless steel); a stack of any of the metals; a stack including any of the metals and any of the alloys (e.g., a stack of stainless steel and aluminum); or a stack including any of the metals and another metal (e.g., a stack of nickel, iron, and nickel) can be used. The positive electrode can 301 and the negative electrode can 302 are electrically connected to the positive electrode 304 and the negative electrode 307, respectively.

The negative electrode 307, the positive electrode 304, and the separator 310 are immersed in the electrolyte. Then, as illustrated in FIG. 4B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 interposed therebetween. In such a manner, the coin-type storage battery 300 can be manufactured.

### Laminated Storage Battery

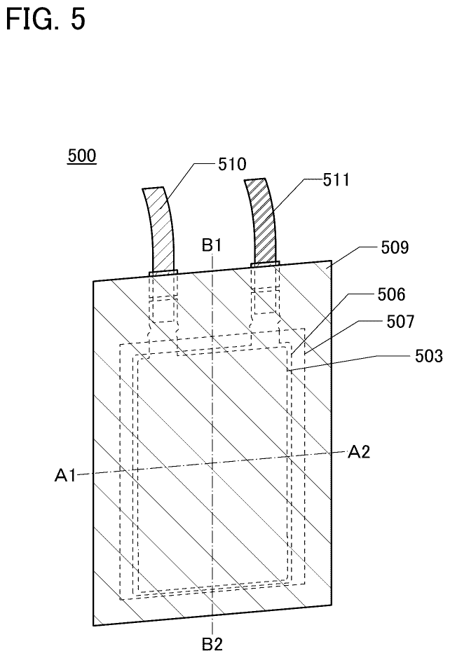

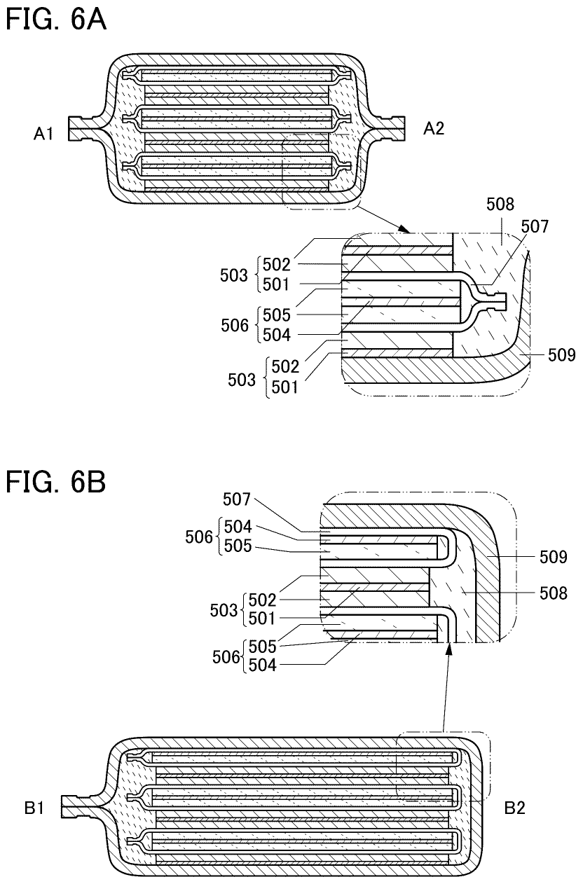

FIG. 5 is an external view of a laminated storage battery 500. FIGS. 6A and 6B are cross-sectional views along dashed-dotted lines A1-A2 and B1-B2, respectively, in FIG. 5. The laminated storage battery 500 is formed with a positive electrode 503 including a positive electrode current collector 501 and a positive electrode active material layer 502, a negative electrode 506 including a negative electrode current collector 504 and a negative electrode active material layer 505, a separator 507, an electrolytic solution 508, and an exterior body 509. The separator 507 is provided between the positive electrode 503 and the negative electrode 506. The electrolytic solution 508 is provided in the region surrounded by the exterior body 509.

In the laminated storage battery 500 illustrated in FIG. 5, the positive electrode current collector 501 and the negative electrode current collector 504 also function as terminals for electrical contact with an external portion. For this reason, each of the positive electrode current collector 501 and the negative electrode current collector 504 is provided so as to be partly exposed to the outside of the exterior body 509.

As the exterior body 509 in the laminated storage battery 500, for example, a laminate film having a three-layer structure where a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide resin, a polyester resin, or the like is provided as the outer surface of the exterior body over the metal thin film can be used. With such a three-layer structure, permeation of an electrolytic solution and a gas can be blocked and an insulating property and resistance to the electrolytic solution can be obtained.

### Cylindrical Storage Battery

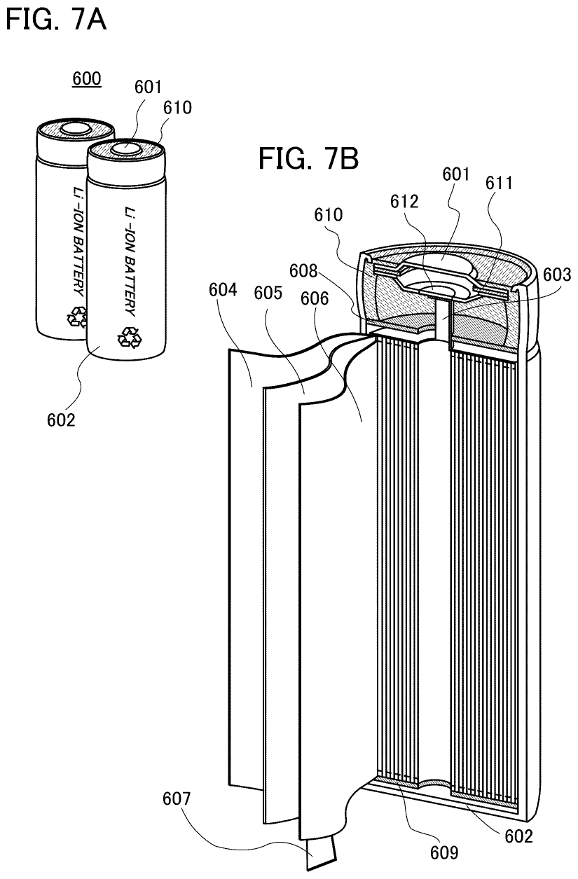

Next, an example of a cylindrical storage battery will be described with reference to FIGS. 7A and 7B. As illustrated in FIG. 7A, a cylindrical storage battery 600 includes a positive electrode cap (battery cap) 601 on the top surface and a battery can (outer can) 602 on the side surface and bottom surface. The positive electrode cap and the battery can 602 are insulated from each other by a gasket (insulating gasket) 610.

FIG. 7B is a diagram schematically illustrating a cross section of the cylindrical storage battery. Inside the battery can 602 having a hollow cylindrical shape, a battery element in which a strip-like positive electrode 604 and a strip-like negative electrode 606 are wound with a stripe-like separator 605 interposed therebetween is provided. Although not illustrated, the battery element is wound around a center pin. One end of the battery can 602 is closed and the other end thereof is open. For the battery can 602, a metal having a corrosion-resistant property to a liquid such as an electrolytic solution in charging and discharging a secondary battery, such as nickel, aluminum, or titanium; an alloy of any of the metals; an alloy containing any of the metals and another metal (e.g., stainless steel); a stack of any of the metals; a stack including any of the metals and any of the alloys (e.g., a stack of stainless steel and aluminum); or a stack including any of the metals and another metal (e.g., a stack of nickel, iron, and nickel) can be used. Inside the battery can 602, the battery element in which the positive electrode, the negative electrode, and the separator are wound is interposed between a pair of insulating plates 608 and 609 which face each other. Further, a nonaqueous electrolytic solution (not illustrated) is injected inside the battery can 602 provided with the battery element. As the nonaqueous electrolytic solution, a nonaqueous electrolytic solution which is similar to those of the above coin-type storage battery and the laminated storage battery can be used.

The positive electrode 604 and the negative electrode 606 can be manufactured in a manner similar to that of the positive electrode and the negative electrode of the coin-type storage battery described above except that active materials are formed on both sides of the current collectors owing to the winding of the positive electrode and the negative electrode of the cylindrical storage battery. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. Further, the PTC element 611, which serves as a thermally sensitive resistor whose resistance increases as temperature rises, limits the amount of current by increasing the resistance, in order to prevent abnormal heat generation. Note that barium titanate (BaTiO₃)-based semiconductor ceramic or the like can be used for the PTC element.

Note that in this embodiment, the coin-type storage battery, the laminated storage battery, and the cylindrical storage battery are given as examples of the storage battery; however, any of storage batteries with a variety of shapes, such as a sealed storage battery and a square-type storage battery, can be used. Further, a structure in which a plurality of positive electrodes, a plurality of negative electrodes, and a plurality of separators are stacked or wound may be employed.

As the positive electrodes and the negative electrodes of the coin-type storage battery 300, the storage battery 500, and the storage battery 600, which are described in this embodiment, electrodes formed by the manufacturing method of a storage battery electrode of one embodiment of the present invention are used. Thus, the discharge capacity of the coin-type storage battery 300, the storage battery 500, and the storage battery 600 can be increased.

In this embodiment, one embodiment of the present invention has been described. Note that one embodiment of the present invention is not limited thereto. In other words, since various embodiments of the invention are described in this embodiment, one embodiment of the present invention is not limited to a particular embodiment. Although an example of application to a lithium-ion secondary battery is described as one embodiment of the present invention, one embodiment of the present invention is not limited to this example. Depending on circumstances or conditions, one embodiment of the present invention can be used for a variety of secondary batteries such as a lead storage battery, a lithium-ion polymer secondary battery, a nickel-hydrogen storage battery, a nickel-cadmium storage battery, a nickel-iron storage battery, a nickel-zinc storage battery, and a silver oxide-zinc storage battery, or a primary battery, a capacitor, or a lithium ion capacitor. Alternatively, one embodiment of the present invention can be used for a solid-state battery or an air battery. Depending on circumstances or conditions, for example, one embodiment of the present invention is not necessarily applied to a lithium-ion secondary battery. This embodiment can be implemented in combination with any of the other embodiments as appropriate.

### Embodiment 4

A storage battery including the storage battery electrode of one embodiment of the present invention can be used for power supplies of a variety of electric devices driven by electric power.

Specific examples of electric devices each utilizing a storage battery including the storage battery electrode of one embodiment of the present invention are as follows: display devices of televisions, monitors, and the like, lighting devices, desktop personal computers and notebook personal computers, word processors, image reproduction devices which reproduce still images and moving images stored in recording media such as digital versatile discs (DVDs), portable CD players, portable radios, tape recorders, headphone stereos, stereos, table clocks, wall clocks, cordless phone handsets, transceivers, mobile phones, car phones, portable game machines, calculators, portable information terminals, electronic notebooks, e-book readers, electronic translators, audio input devices, video cameras, digital still cameras, toys, electric shavers, high-frequency heating appliances such as microwave ovens, electric rice cookers, electric washing machines, electric vacuum cleaners, water heaters, electric fans, hair dryers, air-conditioning systems such as air conditioners, humidifiers, and dehumidifiers, dishwashers, dish dryers, clothes dryers, futon dryers, electric refrigerators, electric freezers, electric refrigerator-freezers, freezers for preserving DNA, flashlights, electrical tools such as a chain saw, smoke detectors, and medical equipment such as dialyzers. Further, industrial equipment such as guide lights, traffic lights, conveyor belts, elevators, escalators, industrial robots, power storage systems, and power storage devices for leveling the amount of power supply and smart grid can be given. In addition, moving objects driven by electric motors using electric power from the storage batteries are also included in the category of electric devices. Examples of the moving objects are electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, motorized bicycles including motor-assisted bicycles, motorcycles, electric wheelchairs, golf carts, boats, ships, submarines, helicopters, aircrafts, rockets, artificial satellites, space probes, planetary probes, and spacecrafts.

In the electric devices, the storage battery including the storage battery electrode of one embodiment of the present invention can be used as a main power supply for supplying enough electric power for almost the whole power consumption. Alternatively, in the electric devices, the storage battery including the storage battery electrode of one embodiment of the present invention can be used as an uninterruptible power supply which can supply electric power to the electric devices when the supply of electric power from the main power supply or a commercial power supply is stopped. Still alternatively, in the electric devices, the storage battery including the storage battery electrode of one embodiment of the present invention can be used as an auxiliary power supply for supplying electric power to the electric devices in parallel with the power supply from the main power supply or a commercial power supply.

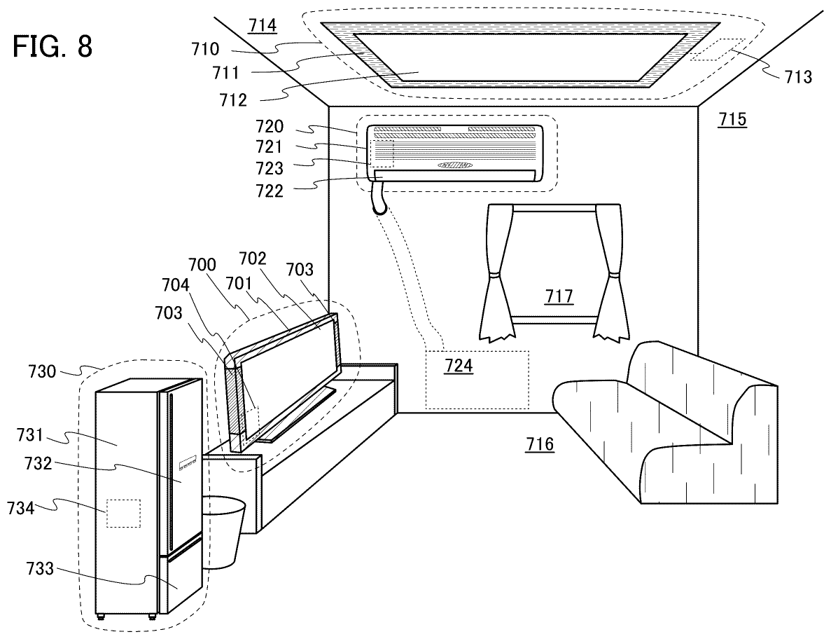

FIG. 8 illustrates specific structures of the electric devices. In FIG. 8, a display device 700 is an example of an electric device including a storage battery 704 including the storage battery electrode of one embodiment of the present invention. Specifically, the display device 700 corresponds to a display device for TV broadcast reception and includes a housing 701, a display portion 702, speaker portions 703, and the storage battery 704. The storage battery 704 including the storage battery electrode of one embodiment of the present invention is provided in the housing 701. The display device 700 can receive electric power from a commercial power supply. Alternatively, the display device 700 can use electric power stored in the storage battery 704. Thus, the display device 700 can be operated with the use of the storage battery 704 including the storage battery electrode of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 702.

Note that the display device includes, in its category, all of information display devices for personal computers, advertisement displays, and the like besides for TV broadcast reception.

In FIG. 8, an installation lighting device 710 is an example of an electric device including a storage battery 713 including the storage battery electrode of one embodiment of the present invention. Specifically, the lighting device 710 includes a housing 711, a light source 712, and the storage battery 713. Although FIG. 8 illustrates the case where the storage battery 713 is provided in a ceiling 714 on which the housing 711 and the light source 712 are installed, the storage battery 713 may be provided in the housing 711. The lighting device 710 can receive electric power from a commercial power supply. Alternatively, the lighting device 710 can use electric power stored in the storage battery 713. Thus, the lighting device 710 can be operated with the use of the storage battery 713 including the storage battery electrode of one embodiment of the present invention as an uninterruptible power supply even when electric power cannot be supplied from a commercial power supply due to power failure or the like.

Note that although the installation lighting device 710 provided in the ceiling 714 is illustrated in FIG. 8 as an example, the storage battery including the storage battery electrode of one embodiment of the present invention can be used in an installation lighting device provided in, for example, a wall 715, a floor 716, a window 717, or the like other than the ceiling 714. Alternatively, the storage battery including the storage battery electrode of one embodiment of the present invention can be used in a tabletop lighting device or the like.

As the light source 712, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 8, an air conditioner including an indoor unit 720 and an outdoor unit 724 is an example of an electric device including a storage battery 723 including the storage battery electrode of one embodiment of the present invention. Specifically, the indoor unit 720 includes a housing 721, an air outlet 722, and the storage battery 723. Although FIG. 8 illustrates the case where the storage battery 723 is provided in the indoor unit 720, the storage battery 723 may be provided in the outdoor unit 724. Alternatively, the storage batteries 723 may be provided in both the indoor unit 720 and the outdoor unit 724. The air conditioner can receive electric power from a commercial power supply. Alternatively, the air conditioner can use electric power stored in the storage battery 723. Particularly in the case where the storage batteries 723 are provided in both the indoor unit 720 and the outdoor unit 724, the air conditioner can be operated with the use of the storage battery 723 including the storage battery electrode of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 8 as an example, the storage battery including the storage battery electrode of one embodiment of the present invention can be used in an air conditioner in which the functions of an indoor unit and an outdoor unit are integrated in one housing.

In FIG. 8, an electric refrigerator-freezer 730 is an example of an electric device including a storage battery 734 including the storage battery electrode of one embodiment of the present invention. Specifically, the electric refrigerator-freezer 730 includes a housing 731, a door for a refrigerator 732, a door for a freezer 733, and the storage battery 734. The storage battery 734 is provided in the housing 731 in FIG. 8. The electric refrigerator-freezer 730 can receive electric power from a commercial power supply. Alternatively, the electric refrigerator-freezer 730 can use electric power stored in the storage battery 734. Thus, the electric refrigerator-freezer 730 can be operated with the use of the storage battery 734 including the storage battery electrode of one embodiment of the present invention as an uninterruptible power supply even when electric power cannot be supplied from a commercial power supply due to power failure or the like.

Note that among the electric devices described above, a high-frequency heating apparatus such as a microwave oven and an electric device such as an electric rice cooker require high power in a short time. The tripping of a breaker of a commercial power supply in use of an electric device can be prevented by using the storage battery including the storage battery electrode of one embodiment of the present invention as an auxiliary power supply for supplying electric power which cannot be supplied enough by a commercial power supply.

In addition, in a time period when electric devices are not used, particularly when the proportion of the amount of electric power which is actually used to the total amount of electric power which can be supplied from a commercial power supply source (such a proportion referred to as a usage rate of electric power) is low, electric power can be stored in the storage battery, whereby the usage rate of electric power can be reduced in a time period when the electric devices are used. For example, in the case of the electric refrigerator-freezer 730, electric power can be stored in the storage battery 734 in night time when the temperature is low and the door for a refrigerator 732 and the door for a freezer 733 are not often opened or closed. Then, in daytime when the temperature is high and the door for a refrigerator 732 and the door for a freezer 733 are frequently opened and closed, the storage battery 734 is used as an auxiliary power supply; thus, the usage rate of electric power in daytime can be reduced.

This embodiment can be implemented in combination with any of the other embodiments as appropriate.

### Embodiment 5

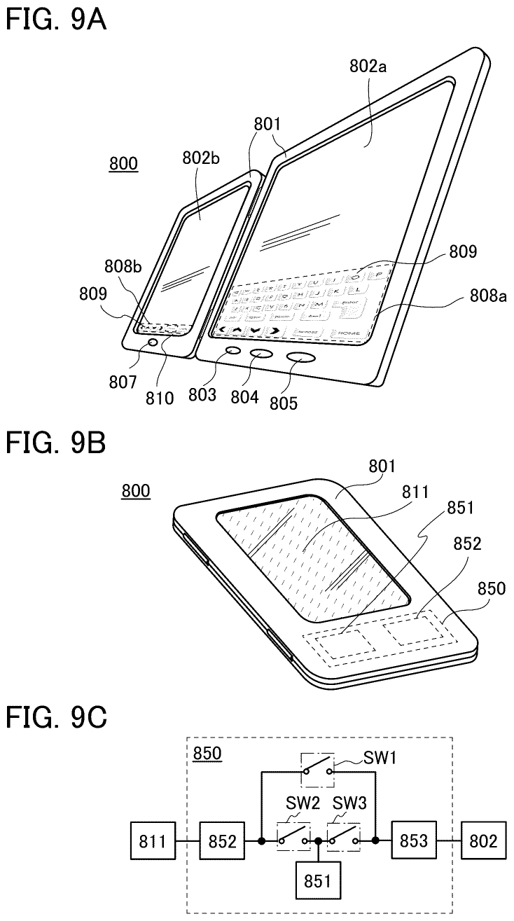

Next, a portable information terminal which is an example of electric devices will be described with reference to FIGS. 9A to 9C.

FIGS. 9A and 9B illustrate a tablet terminal 800 which can be folded. FIG. 9A illustrates the tablet terminal 800 in the state of being unfolded. The tablet terminal includes a housing 801, a display portion 802a, a display portion 802b, a display-mode switching button 803, a power button 804, a power-saving-mode switching button 805, and an operation button 807.

A touch panel area 808a can be provided in part of the display portion 802a, in which area, data can be input by touching displayed operation keys 809. Note that half of the display portion 802a has only a display function and the other half has a touch panel function. However, the structure of the display portion 802a is not limited to this, and all the area of the display portion 802a may have a touch panel function. For example, a keyboard can be displayed on the whole display portion 802a to be used as a touch panel, and the display portion 802b can be used as a display screen.

A touch panel area 808b can be provided in part of the display portion 802b like in the display portion 802a. When a keyboard display switching button 810 displayed on the touch panel is touched with a finger, a stylus, or the like, a keyboard can be displayed on the display portion 802b.

Touch input can be performed in the touch panel area 808a and the touch panel area 808b at the same time.

The display-mode switching button 803 allows switching between a landscape mode and a portrait mode, color display and black-and-white display, and the like. The power-saving-mode switching button 805 allows optimizing the display luminance in accordance with the amount of external light in use which is detected by an optical sensor incorporated in the tablet terminal. In addition to the optical sensor, other detecting devices such as sensors for determining inclination, such as a gyroscope or an acceleration sensor, may be incorporated in the tablet terminal.

Although the display area of the display portion 802a is the same as that of the display portion 802b in FIG. 9A, one embodiment of the present invention is not particularly limited thereto. The display area of the display portion 802a may be different from that of the display portion 802b, and further, the display quality of the display portion 802a may be different from that of the display portion 802b. For example, one of the display portions 802a and 802b may display higher definition images than the other.

FIG. 9B illustrates the tablet terminal 800 in the state of being closed. The tablet terminal 800 includes the housing 801, a solar cell 811, a charge/discharge control circuit 850, a battery 851, and a DC-DC converter 852. FIG. 9B illustrates an example where the charge/discharge control circuit 850 includes the battery 851 and the DC-DC converter 852. The storage battery including the storage battery electrode of one embodiment of the present invention, which is described in the above embodiment, is used as the battery 851.

Since the tablet terminal 800 can be folded, the housing 801 can be closed when the tablet terminal is not in use. Thus, the display portions 802a and 802b can be protected, which permits the tablet terminal 800 to have high durability and improved reliability for long-term use.

The tablet terminal illustrated in FIGS. 9A and 9B can also have a function of displaying various kinds of data (e.g., a still image, a moving image, and a text image), a function of displaying a calendar, a date, the time, or the like on the display portion, a touch-input function of operating or editing data displayed on the display portion by touch input, a function of controlling processing by various kinds of software (programs), and the like.

The solar cell 811, which is attached to a surface of the tablet terminal, can supply electric power to a touch panel, a display portion, an image signal processor, and the like. Note that the solar cell 811 can be provided on one or both surfaces of the housing 801 and thus the battery 851 can be charged efficiently.

The structure and operation of the charge/discharge control circuit 850 illustrated in FIG. 9B will be described with reference to a block diagram of FIG. 9C. FIG. 9C illustrates the solar cell 811, the battery 851, the DC-DC converter 852, a converter 853, switches SW1 to SW3, and the display portion 802. The battery 851, the DC-DC converter 852, the converter 853, and the switches SW1 to SW3 correspond to the charge and discharge control circuit 850 in FIG. 9B.

First, an example of operation in the case where electric power is generated by the solar cell 811 using external light will be described. The voltage of electric power generated by the solar cell is raised or lowered by the DC-DC converter 852 so that the electric power can have a voltage for charging the battery 851. When the display portion 802 is operated with the electric power from the solar cell 811, the switch SW1 is turned on and the voltage of the electric power is raised or lowered by the converter 853 to a voltage needed for operating the display portion 802. In addition, when display on the display portion 802 is not performed, the switch SW1 is turned off and the switch SW2 is turned on so that the battery 851 may be charged.

Although the solar cell 811 is described as an example of power generation means, there is no particular limitation on the power generation means, and the battery 851 may be charged with any of the other means such as a piezoelectric element or a thermoelectric conversion element (Peltier element). For example, the battery 851 may be charged with a non-contact power transmission module capable of performing charging by transmitting and receiving electric power wirelessly (without contact), or any of the other charge means used in combination.

It is needless to say that one embodiment of the present invention is not limited to the electric device illustrated in FIGS. 9A to 9C as long as the electric device is equipped with the storage battery including the storage battery electrode of one embodiment of the present invention, which is described in the above embodiment.

### Embodiment 6

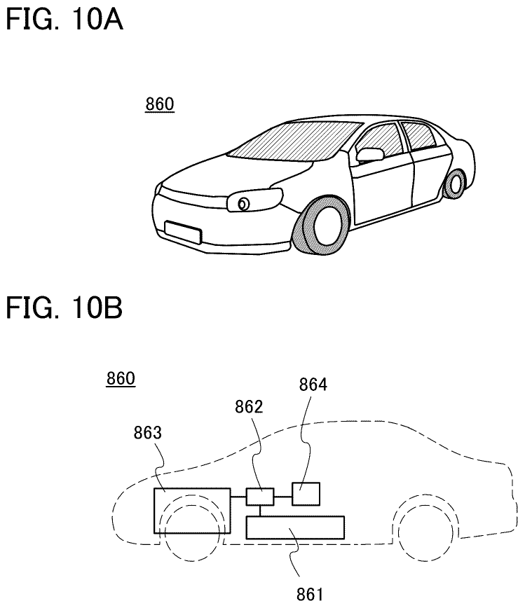

An example of the moving object which is an example of the electric devices will be described with reference to FIGS. 10A and 10B.

The storage battery described in the above embodiment can be used as a control battery. The control battery can be externally charged by electric power supply using a plug-in technique or contactless power feeding. Note that in the case where the moving object is an electric railway vehicle, the electric railway vehicle can be charged by electric power supply from an overhead cable or a conductor rail.

FIGS. 10A and 10B illustrate an example of an electric vehicle. An electric vehicle 860 is equipped with a battery 861. The output of the electric power of the battery 861 is adjusted by a control circuit 862 and the electric power is supplied to a driving device 863. The control circuit 862 is controlled by a processing unit 864 including a ROM, a RAM, a CPU, and the like which are not illustrated.

The driving device 863 includes a DC motor or an AC motor either alone or in combination with an internal-combustion engine. The processing unit 864 outputs a control signal to the control circuit 862 based on input data such as data on operation (e.g., acceleration, deceleration, or stop) of a driver or data during driving (e.g., data on an upgrade or a downgrade, or data on a load on a driving wheel) of the electric vehicle 860. The control circuit 862 adjusts the electric energy supplied from the battery 861 in accordance with the control signal of the processing unit 864 to control the output of the driving device 863. In the case where the AC motor is mounted, although not illustrated, an inverter which converts direct current into alternate current is also incorporated.

The battery 861 can be charged by external electric power supply using a plug-in technique. For example, the battery 861 is charged through a power plug from a commercial power supply. The battery 861 can be charged by converting the supplied power into DC constant voltage having a predetermined voltage level through a converter such as an AC-DC converter. The use of the storage battery including the storage battery electrode of one embodiment of the present invention as the battery 861 can be conducive to an increase in battery capacity, leading to an improvement in convenience. When the battery 861 itself can be more compact and more lightweight as a result of improved characteristics of the battery 861, the vehicle can be lightweight, leading to an increase in fuel efficiency.

Note that it is needless to say that one embodiment of the present invention is not limited to the electric device described above as long as the storage battery of one embodiment of the present invention is included.

This embodiment can be implemented in combination with any of the other embodiments as appropriate.

### Embodiment 7

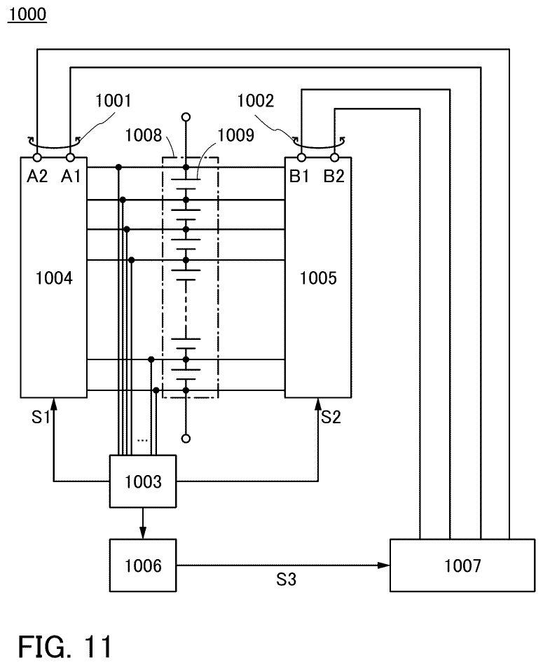

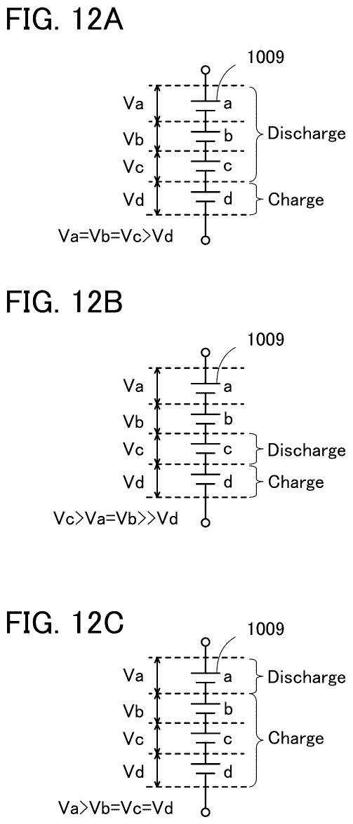

A battery management unit (BMU) which can be combined with a battery cell (e.g., the power storage device described in Embodiment 3) containing the material described in the above embodiment, and a transistor suitable for a circuit included in the battery management unit will be described with reference to FIG. 11, FIGS. 12A to 12C, FIG. 13, FIG. 14, FIGS. 15A to 15C, FIG. 16, and FIG. 17. In this embodiment, a battery management unit of a power storage device that includes battery cells connected in series will be particularly described.

When a plurality of battery cells connected in series are charged and discharged repeatedly, each battery cell has different capacity (output voltage) from one another due to the variation in characteristics among the battery cells. Discharge capacities of all of the battery cells connected in series depend on a battery cell with small capacity. Capacity variation reduces the discharge capacity. Charging based on a battery cell with small capacity may cause insufficient charging. Charging based on a battery cell with high capacity may cause overcharge.

Thus, the battery management unit of the power storage device that includes the battery cells connected in series has a function of reducing capacity variation among the battery cells which causes insufficient charging or overcharge. Examples of circuit structures for reducing capacity variation among the battery cells include a resistive type, a capacitor type, and an inductor type; here, a circuit structure which can reduce capacity variation using a transistor with a low off-state current is explained as an example.

A transistor including an oxide semiconductor in its channel formation region (an OS transistor) is preferably used as the transistor with a low off-state current. When an OS transistor with a low off-state current is used in the circuit structure of the battery management unit of the power storage device, the amount of electric charge leaking from a battery cell can be reduced, and reduction in capacity over time can be suppressed.

As the oxide semiconductor used in the channel formation region, an In-M-Zn oxide (M is Ga, Sn, Y, Zr, La, Ce, or Nd) is used. In the case where a target having the atomic ratio of the metal elements of In:M: Zn=x₁y₁:z₁ is used for forming an oxide semiconductor film, x₁/y₁ is preferably greater than or equal to 1/3 and less than or equal to 6 and further preferably greater than or equal to 1 and less than or equal to 6, and z₁/y₁ is preferably greater than or equal to 1/3 and less than or equal to 6 and further preferably greater than or equal to 1 and less than or equal to 6. Note that when z₁/y₁ is greater than or equal to 1 and less than or equal to 6, a CAAC-OS film as the oxide semiconductor film is easily formed.

Here, a CAAC-OS film is described.

The CAAC-OS film is one of oxide semiconductor films having a plurality of c-axis aligned crystal parts.

With a transmission electron microscope (TEM), a combined analysis image (also referred to as a high-resolution TEM image) of a bright-field image and a diffraction pattern of the CAAC-OS film is observed. Consequently, a plurality of crystal parts are observed clearly. However, in the high-resolution TEM image, a boundary between crystal parts, i.e., a grain boundary is not observed clearly. Thus, in the CAAC-OS film, a reduction in electron mobility due to the grain boundary is less likely to occur.

According to the high-resolution cross-sectional TEM image of the CAAC-OS film observed in a direction substantially parallel to a sample surface, metal atoms are arranged in a layered manner in the crystal parts. Each metal atom layer has a morphology that reflects a surface over which the CAAC-OS film is formed (also referred to as a formation surface) or a top surface of the CAAC-OS film, and is provided parallel to the formation surface or the top surface of the CAAC-OS film.

On the other hand, according to the high-resolution planar TEM image of the CAAC-OS film observed in a direction substantially perpendicular to the sample surface, metal atoms are arranged in a triangular or hexagonal configuration in the crystal parts. However, there is no regularity of arrangement of metal atoms between different crystal parts.

The CAAC-OS film is subjected to structural analysis with an X-ray diffraction (XRD) apparatus. For example, when the CAAC-OS film including an InGaZnO₄ crystal is analyzed by an out-of-plane method, a peak appears frequently when the diffraction angle (2θ) is around 31°. This peak is assigned to the (009) plane of the InGaZnO₄ crystal, which indicates that crystals in the CAAC-OS film have c-axis alignment, and that the c-axes are aligned in a direction substantially perpendicular to the formation surface or the top surface of the CAAC-OS film.

Note that when the CAAC-OS film with an InGaZnO₄ crystal is analyzed by an out-of-plane method, a peak of 2θ may also be observed at around 36°, in addition to the peak of 2θ at around 31°. The peak of 2θ at around 36° indicates that a crystal having no c-axis alignment is included in part of the CAAC-OS film. It is preferable that in the CAAC-OS film, a peak of 2θ appear at around 31° and a peak of 2θ not appear at around 36°.

The CAAC-OS film is an oxide semiconductor film having low impurity concentration. The impurity is an element other than the main components of the oxide semiconductor film, such as hydrogen, carbon, silicon, or a transition metal element. In particular, an element that has higher bonding strength to oxygen than a metal element included in the oxide semiconductor film, such as silicon, disturbs the atomic order of the oxide semiconductor film by depriving the oxide semiconductor film of oxygen and causes a decrease in crystallinity. Furthermore, a heavy metal such as iron or nickel, argon, carbon dioxide, or the like has a large atomic radius (molecular radius), and thus disturbs the atomic order of the oxide semiconductor film and causes a decrease in crystallinity when it is contained in the oxide semiconductor film. Note that the impurity contained in the oxide semiconductor film might serve as a carrier trap or a carrier generation source.

The CAAC-OS film is an oxide semiconductor film having low density of defect states. In some cases, oxygen vacancies in the oxide semiconductor film serve as carrier traps or serve as carrier generation sources when hydrogen is captured therein.

The state in which impurity concentration is low and density of defect states is low (the number of oxygen vacancies is small) is referred to as “highly purified intrinsic” or “substantially highly purified intrinsic.” A highly purified intrinsic or substantially highly purified intrinsic oxide semiconductor film has few carrier generation sources, and thus can have low carrier density. Thus, a transistor including the oxide semiconductor film rarely has negative threshold voltage (is rarely normally on). The highly purified intrinsic or substantially highly purified intrinsic oxide semiconductor film has few carrier traps. Accordingly, the transistor including the oxide semiconductor film has few variations in electrical characteristics and high reliability. Charge trapped by the carrier traps in the oxide semiconductor film takes a long time to be released and may behave like fixed charge. Thus, the transistor that includes the oxide semiconductor film having high impurity concentration and high density of defect states has unstable electrical characteristics in some cases.

In a transistor including the CAAC-OS film, changes in electrical characteristics of the transistor due to irradiation with visible light or ultraviolet light are small.

Since the OS transistor has a wider band gap than a transistor including silicon in its channel formation region (a Si transistor), dielectric breakdown at the time when a high voltage is applied is unlikely to occur. Although a voltage of several hundreds of volts is generated when battery cells are connected in series, the above-described OS transistor is suitable for the circuit structure of the battery management unit, which is used for such battery cells, in the power storage device.

FIG. 11 is an example of a block diagram of the power storage device. A power storage device 1000 illustrated in FIG. 11 includes a terminal pair 1001, a terminal pair 1002, a switching control circuit 1003, a switching circuit 1004, a switching circuit 1005, a voltage transformation control circuit 1006, a voltage transformer circuit 1007, and a battery portion 1008 including a plurality of battery cells 1009 connected in series.

In the power storage device 1000 illustrated in FIG. 11, a portion including the terminal pair 1001, the terminal pair 1002, the switching control circuit 1003, the switching circuit 1004, the switching circuit 1005, the voltage transformation control circuit 1006, and the voltage transformer circuit 1007 can be referred to as a battery management unit.

The switching control circuit 1003 controls operations of the switching circuits 1004 and 1005. Specifically, the switching control circuit 1003 determines battery cells to be discharged (a discharge battery cell group) and battery cells to be charged (a charge battery cell group) in accordance with voltage measured for every battery cell 1009.

Furthermore, the switching control circuit 1003 outputs a control signal S1 and a control signal S2 on the basis of the determined discharge battery cell group and the determined charge battery cell group. The control signal S1 is output to the switching circuit 1004. The control signal S1 controls the switching circuit 1004 so that the terminal pair 1001 and the discharge battery cell group are connected to each other. The control signal S2 is output to the switching circuit 1005. The control signal S2 controls the switching circuit 1005 so that the terminal pair 1002 and the charge battery cell group are connected to each other.

The switching control circuit 1003 generates the control signal S1 and the control signal S2 on the basis of connection relation of the switching circuit 1004, the switching circuit 1005, and the voltage transformer circuit 1007 so that terminals having the same polarity are connected to each other in the terminal pair 1001 and the discharge battery cell group, or terminals having the same polarity are connected to each other in the terminal pair 1002 and the charge battery cell group.

An operation of the switching control circuit 1003 is described in detail.

First, the switching control circuit 1003 measures the voltage of each of a plurality of the battery cells 1009. Then, the switching control circuit 1003 determines the battery cell 1009 having a voltage higher than a predetermined threshold value as a high-voltage battery cell (high-voltage cell) and the battery cell 1009 having a voltage lower than the predetermined threshold value as a low-voltage battery cell (low-voltage cell), for example.

As a method to determine whether a battery cell is a high-voltage cell or a low-voltage cell, any of various methods can be employed. For example, the switching control circuit 1003 may determine whether each battery cell 1009 is a high-voltage cell or a low-voltage cell on the basis of the voltage of the battery cell 1009 having a highest voltage or a lowest voltage among a plurality of the battery cells 1009. In this case, the switching control circuit 1003 can determine whether each battery cell 1009 is a high-voltage cell or a low-voltage cell by determining whether or not a ratio of a voltage of each battery cell 1009 to the reference voltage is the predetermined value or more. Then, the switching control circuit 1003 determines a charge battery cell group and a discharge battery cell group on the basis of the determination result.

Note that high-voltage cells and low-voltage cells are possibly mixed in various states in a plurality of the battery cells 1009. The switching control circuit 1003 determines a portion having the largest number of consecutive high-voltage cells connected in series as the discharge battery cell group of mixed high-voltage cells and low-voltage cells, for example. Furthermore, the switching control circuit 1003 determines a portion having the largest number of consecutive low-voltage cells connected in series as the charge battery cell group, for example. In addition, the switching control circuit 1003 may preferentially select the battery cells 1009 which are nearly overcharged or overdischarged as the discharge battery cell group or the charge battery cell group.

Here, operation examples of the switching control circuit 1003 in this embodiment are described with reference to FIGS. 12A to 12C. FIGS. 12A to 12C illustrate operation examples of the switching control circuit 1003. Note that FIGS. 12A to 12C each illustrate the case where four battery cells 1009 are connected in series as an example for convenience of explanation.

FIG. 12A shows the case where the relation Va=Vb=Vc>Vd is satisfied where Va, Vb, Vc, and Vd are voltages of a battery cell a, a battery cell b, a battery cell c, and a battery cell d, respectively. That is, three consecutive high-voltage cells a to c and one low-voltage cell d are connected in series. In that case, the switching control circuit 1003 determines the series of three high-voltage cells a to c as the discharge battery cell group and the low-voltage cell d as the charge battery cell group.

FIG. 12B shows the case where the relation Vc>Va=Vb>>Vd is satisfied. That is, two consecutive low-voltage cells a and b, one high-voltage cell c, and one low-voltage cell d which is nearly overdischarged are connected in series. In that case, the switching control circuit 1003 determines the high-voltage cell c as the discharge battery cell group. The switching control circuit 1003 preferentially determines the low-voltage cell d, which is nearly overdischarged, as the charge battery cell group instead of the two consecutive low-voltage cells a and b.

FIG. 12C shows the case where the relation Va>Vb=Vc=Vd is satisfied. That is, one high-voltage cell a and three consecutive low-voltage cells b to d are connected in series. In that case, the switching control circuit 1003 determines the high-voltage cell a as the discharge battery cell group and the three consecutive low-voltage cells b to d as the charge battery cell group.

On the basis of the determination result shown in the examples of FIGS. 12A to 12C, the switching control circuit 1003 outputs the control signal S1 and the control signal S2 to the switching circuit 1004 and the switching circuit 1005, respectively. The control signal S1 contains information indicating the discharge battery cell group being the connection destination of the switching circuit 1004. The control signal S2 contains information indicating the charge battery cell group being a connection destination of the switching circuit 1005.

The above is the detailed description of the operation of the switching control circuit 1003.

The switching circuit 1004 sets the discharge battery cell group, which is determined by the switching control circuit 1003, as the connection destination of the terminal pair 1001 in response to the control signal S1 output from the switching control circuit 1003.

The terminal pair 1001 includes a pair of terminals A1 and A2. The switching circuit 1004 sets the connection destination of the terminal pair 1001 by connecting one of the pair of terminals A1 and A2 to a positive electrode terminal of the battery cell 1009 positioned on the most upstream side (on the high potential side) of the discharge battery cell group, and the other to a negative electrode terminal of the battery cell 1009 positioned on the most downstream side (on the low potential side) of the discharge battery cell group. Note that the switching circuit 1004 can recognize the position of the discharge battery cell group on the basis of the information contained in the control signal S1.

The switching circuit 1005 sets the charge battery cell group, which is determined by the switching control circuit 1003, as the connection destination of the terminal pair 1002 in response to the control signal S2 output from the switching control circuit 1003.

The terminal pair 1002 includes a pair of terminals B1 and B2. The switching circuit 1005 sets the connection destination of the terminal pair 1002 by connecting one of the pair of terminals B1 and B2 to a positive electrode terminal of the battery cell 1009 positioned on the most upstream side (on the high potential side) of the charge battery cell group, and the other to a negative electrode terminal of the battery cell 1009 positioned on the most downstream side (on the low potential side) of the charge battery cell group. Note that the switching circuit 1005 can recognize the position of the charge battery cell group on the basis of the information contained in the control signal S2.

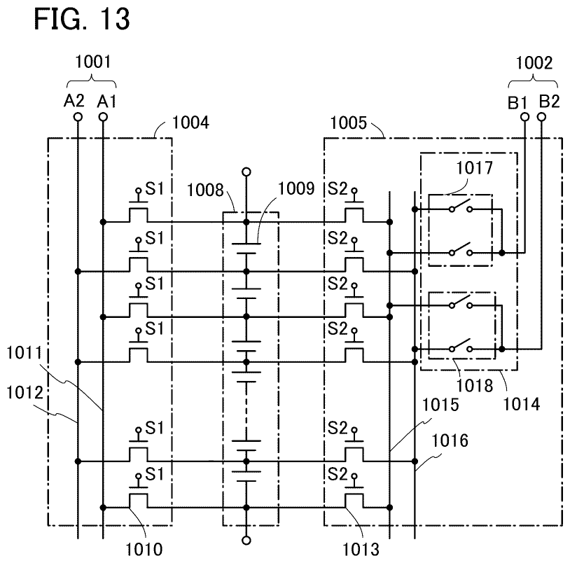

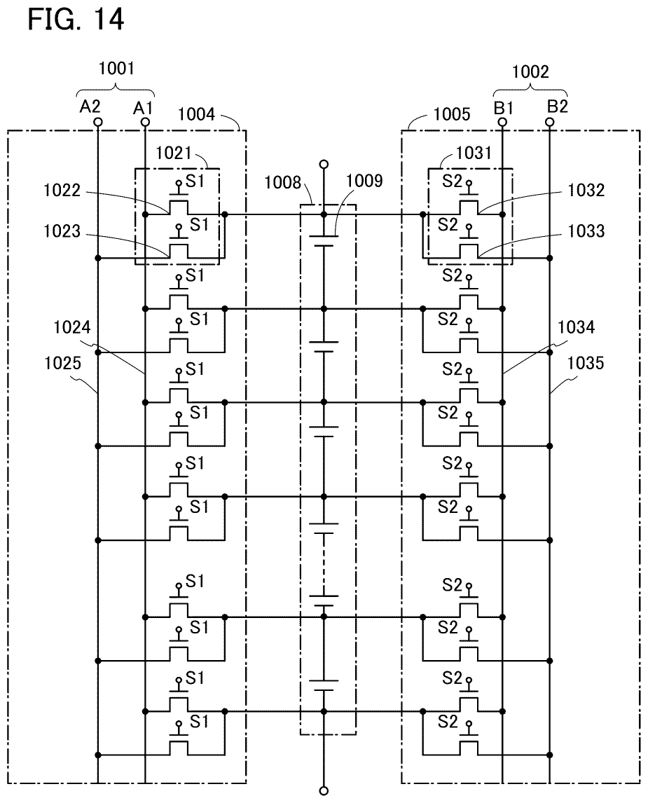

FIG. 13 and FIG. 14 are circuit diagrams showing configuration examples of the switching circuits 1004 and 1005.

In FIG. 13, the switching circuit 1004 includes a plurality of transistors 1010, a bus 1011, and a bus 1012. The bus 1011 is connected to the terminal A1. The bus 1012 is connected to the terminal A2. Sources or drains of a plurality of the transistors 1010 are connected alternately to the bus 1011 and the bus 1012. The drains or the sources of a plurality of the transistors 1010 are each connected between two adjacent battery cells 1009.

The drain or the source of the transistor 1010 on the most upstream side is connected to a positive electrode terminal of the battery cell 1009 on the most upstream side of the battery portion 1008. The drain or the source the transistor 1010 on the most downstream side is connected to a negative electrode terminal of the battery cell 1009 on the most downstream side of the battery portion 1008.

The switching circuit 1004 connects the discharge battery cell group to the terminal pair 1001 by bringing one of a plurality of the transistors 1010 which are connected to the bus 1011 and one of a plurality of the transistors 1010 which are connected to the bus 1012 into an on state in response to the control signal S1 supplied to gates of a plurality of the transistors 1010. Accordingly, the positive electrode terminal of the battery cell 1009 on the most upstream side of the discharge battery cell group is connected to one of the pair of terminals A1 and A2. In addition, the negative electrode terminal of the battery cell 1009 on the most downstream side of the discharge battery cell group is connected to the other of the pair of terminals A1 and A2 (i.e., a terminal which is not connected to the positive electrode terminal).

An OS transistor is preferably used as the transistor 1010. Since the off-state current of the OS transistor is low, the amount of electric charge leaking from a battery cell which does not belong to the discharge battery cell group can be reduced, and reduction in capacity over time can be suppressed. In addition, dielectric breakdown in the OS transistor at the time when a high voltage is applied is unlikely to occur. Therefore, the battery cell 1009 and the terminal pair 1001, which are connected to the transistor 1010 in an off state, can be insulated from each other even when an output voltage of the discharge battery cell group is high.

In FIG. 13, the switching circuit 1005 includes a plurality of transistors 1013, a current control switch 1014, a bus 1015, and a bus 1016. The bus 1015 and the bus 1016 are provided between a plurality of the transistors 1013 and the current control switch 1014. Sources or drains of a plurality of the transistors 1013 are connected alternately to the bus 1015 and the bus 1016. The drains or the sources of a plurality of the transistors 1013 are each connected between two adjacent battery cells 1009.

The drain or the source of the transistor 1013 on the most upstream side is connected to the positive electrode terminal of the battery cell 1009 on the most upstream side of the battery portion 1008. The drain or the source of the transistor 1013 on the most downstream side is connected to the negative electrode terminal of the battery cell 1009 on the most downstream side of the battery portion 1008.

An OS transistor is preferably used as the transistor 1013 like the transistor 1010. Since the off-state current of the OS transistor is low, the amount of electric charge leaking from the battery cell which does not belong to the charge battery cell group can be reduced, and reduction in capacity over time can be suppressed. In addition, dielectric breakdown in the OS transistor at the time when a high voltage is applied is unlikely to occur. Therefore, the battery cell 1009 and the terminal pair 1002, which are connected to the transistor 1013 in an off state, can be insulated from each other even when charging voltage of the charge battery cell group is high.

The current control switch 1014 includes a switch pair 1017 and a switch pair 1018. One end of the switch pair 1017 is connected to the terminal B1. The other end of the switch pair 1017 is divided into two switches. One switch is connected to the bus 1015, and the other switch is connected to the bus 1016. One end of the switch pair 1018 is connected to the terminal B2. The other end of the switch pair 1018 is divided into two switches. One switch is connected to the bus 1015, and the other switch is connected to the bus 1016.

OS transistors are preferably used for the switches included in the switch pair 1017 and the switch pair 1018 like the transistors 1010 and 1013.

The switching circuit 1005 controls the combination of on and off states of the transistors 1013 and the current control switch 1014 in response to the control signal S2 to connect the charge battery cell group and the terminal pair 1002.

The switching circuit 1005 connects the charge battery cell group and the terminal pair 1002 in the following manner, for example.

The switching circuit 1005 brings the transistor 1013 connected to the positive electrode terminal of the battery cell 1009 on the most upstream side of the charge battery cell group into an on state in response to the control signal S2 supplied to gates of a plurality of the transistors 1013. In addition, the switching circuit 1005 brings the transistor 1013 connected to the negative electrode terminal of the battery cell 1009 on the most downstream side of the charge battery cell group into an on state in response to the control signal S2 supplied to the gates of a plurality of the transistors 1013.

The polarities of voltages applied to the terminal pair 1002 might vary depending on the structures of the discharge battery cell group and the voltage transformer circuit 1007 connected to the terminal pair 1001. In order to supply current in a direction for charging the charge battery cell group, terminals with the same polarity need to be connected to each other in the terminal pair 1002 and the charge battery cell group. Thus, the current control switch 1014 is controlled by the control signal S2 so that the connection destination of the switch pair 1017 and that of the switch pair 1018 are changed depending on the polarities of the voltages applied to the terminal pair 1002.

The state where voltages are applied to the terminal pair 1002 so as to make the terminal B1 a positive electrode and the terminal B2 a negative electrode is described as an example. In the case where the battery cell 1009 on the most downstream side of the battery portion 1008 is in the charge battery cell group, the switch pair 1017 is controlled in response to the control signal S2 to be connected to the positive electrode terminal of the battery cell 1009. That is, the switch connected to the bus 1016 in the switch pair 1017 is turned on, and the switch connected to the bus 1015 in the switch pair 1017 is turned off. In contrast, the switch pair 1018 is controlled in response to the control signal S2 to be connected to the negative electrode terminal of the battery cell 1009 on the most downstream side of the battery portion 1008. That is, the switch connected to the bus 1015 in the switch pair 1018 is turned on, and the switch connected to the bus 1016 in the switch pair 1018 is turned off. In this manner, terminals with the same polarity are connected to each other in the terminal pair 1002 and the charge battery cell group. Accordingly, the current which flows from the terminal pair 1002 is controlled to be supplied in a direction for charging the charge battery cell group.

Instead of the switching circuit 1005, the switching circuit 1004 may include the current control switch 1014. In that case, the polarities of the voltages applied to the terminal pair 1002 are controlled by controlling the polarities of the voltages applied to the terminal pair 1001 in response to the operation of the current control switch 1014 and the control signal S1. Thus, the current control switch 1014 controls the direction of current which flows to the charge battery cell group from the terminal pair 1002.

FIG. 14 is a circuit diagram illustrating structure examples of the switching circuit 1004 and the switching circuit 1005 which are different from those in FIG. 13.

In FIG. 14, the switching circuit 1004 includes a plurality of transistor pairs 1021, a bus 1024, and a bus 1025. The bus 1024 is connected to the terminal A1. The bus 1025 is connected to the terminal A2. One end of each of a plurality of the transistor pairs 1021 is divided into a transistor 1022 and a transistor 1023. A source or a drain of the transistor 1022 is connected to the bus 1024. A source or a drain of the transistor 1023 is connected to the bus 1025. In addition, the other end of each of a plurality of the transistor pairs is connected between two adjacent battery cells 1009. The other end of the transistor pair 1021 on the most upstream side of a plurality of the transistor pairs 1021 is connected to a positive electrode terminal of the battery cell 1009 on the most upstream side of the battery portion 1008. The other end of the transistor pair 1021 on the most downstream side of a plurality of the transistor pairs 1021 is connected to a negative electrode terminal of the battery cell 1009 on the most downstream side of the battery portion 1008.

The switching circuit 1004 switches the connection destination of the transistor pair 1021 to one of the terminal A1 and the terminal A2 by turning on or off the transistors 1022 and 1023 in response to the control signal S1. Specifically, when the transistor 1022 is turned on, the transistor 1023 is turned off, in which case the connection destination of the transistor pair 1021 is the terminal A1. In contrast, when the transistor 1023 is turned on, the transistor 1022 is turned off, in which case the connection destination of the transistor pair 1021 is the terminal A2. Which of the transistors 1022 and 1023 is turned on is determined by the control signal S1.

Two transistor pairs 1021 are used to connect the terminal pair 1001 and the discharge battery cell group. Specifically, the connection destinations of the two transistor pairs 1021 are determined on the basis of the control signal S1, and the discharge battery cell group and the terminal pair 1001 are connected to each other. The connection destinations of the two transistor pairs 1021 are controlled by the control signal S1 so that one of the connection destinations is the terminal A1 and the other is the terminal A2.

The switching circuit 1005 includes a plurality of transistor pairs 1031, a bus 1034, and a bus 1035. The bus 1034 is connected to the terminal B1. The bus 1035 is connected to the terminal B2. One end of each of a plurality of the transistor pairs 1031 is divided into a transistor 1032 and a transistor 1033. A source or a drain of the transistor 1032 is connected to the bus 1034. A source or a drain of the transistor 1033 is connected to the bus 1035. The other end of each of a plurality of the transistor pairs 1031 is connected between two adjacent battery cells 1009. The other end of the transistor pair 1031 on the most downstream side of a plurality of the transistor pairs 1031 is connected to the negative electrode terminal of the battery cell 1009 on the most downstream side of the battery portion 1008. The other end of the transistor pair 1031 on the most upstream side of a plurality of the transistor pairs 1031 is connected to the positive electrode terminal of the battery cell 1009 on the most upstream side of the battery portion 1008.

The switching circuit 1005 switches the connection destination of the transistor pair 1031 to one of the terminal B1 and the terminal B2 by turning on or off the transistors 1032 and 1033 in response to the control signal S2. Specifically, when the transistor 1032 is turned on, the transistor 1033 is turned off, in which case the connection destination of the transistor pair 1031 is the terminal B1. In contrast, when the transistor 1033 is turned on, the transistor 1032 is turned off, in which case the connection destination of the transistor pair 1031 is the terminal B2. Which of the transistors 1032 and 1033 is turned on is determined by the control signal S2.

Two transistor pairs 1031 are used to connect the terminal pair 1002 and the charge battery cell group. Specifically, the connection destinations of the two transistor pairs 1031 are determined on the basis of the control signal S2, and the charge battery cell group and the terminal pair 1002 are connected to each other. The connection destinations of the two transistor pairs 1031 are controlled by the control signal S2 so that one of the connection destinations is the terminal B1 and the other is the terminal B2.

The connection destinations of the two transistor pairs 1031 are determined by the polarities of the voltages applied to the terminal pair 1002. Specifically, in the case where voltages which make the terminal B1 a positive electrode and the terminal B2 a negative electrode are applied to the terminal pair 1002, the transistor pair 1031 on the upstream side is controlled by the control signal S2 so that the transistor 1032 is turned on and the transistor 1033 is turned off while the transistor pair 1031 on the downstream side is controlled by the control signal S2 so that the transistor 1033 is turned on and the transistor 1032 is turned off. In the case where voltages which make the terminal B1 a negative electrode and the terminal B2 a positive electrode is applied to the terminal pair 1002, the transistor pair 1031 on the upstream side is controlled by the control signal S2 so that the transistor 1033 is turned on and the transistor 1032 is turned off while the transistor pair 1031 on the downstream side is controlled by the control signal S2 so that the transistor 1032 is turned on and the transistor 1033 is turned off. In this manner, terminals with the same polarity are connected to each other in the terminal pair 1002 and the charge battery cell group. Accordingly, the current which flows from the terminal pair 1002 is controlled to be supplied in a direction for charging the charge battery cell group.

The voltage transformation control circuit 1006 controls operation of the voltage transformer circuit 1007. The voltage transformation control circuit 1006 generates a voltage transformation signal S3 for controlling the operation of the voltage transformer circuit 1007 on the basis of the number of the battery cells 1009 included in the discharge battery cell group and the number of the battery cells 1009 included in the charge battery cell group and outputs the voltage transformation signal S3 to the voltage transformer circuit 1007.

In the case where the discharge battery cell group includes more battery cells 1009 than the charge battery cell group, it is necessary to prevent excessive application of charging voltage to the charge battery cell group. Thus, the voltage transformation control circuit 1006 outputs the voltage transformation signal S3 for controlling the voltage transformer circuit 1007 so that a discharging voltage (Vdis) is lowered within a range where the charge battery cell group can be charged.

In the case where the number of the battery cells 1009 included in the discharge battery cell group is less than or equal to the number of the battery cells 1009 included in the charge battery cell group, a voltage necessary for charging the charge battery cell group needs to be secured. Therefore, the voltage transformation control circuit 1006 outputs the voltage transformation signal S3 for controlling the voltage transformer circuit 1007 so that the discharging voltage (Vdis) is raised within a range where excessive charging voltage is not applied to the charge battery cell group.

The voltage value of the excessive charging voltage is determined in the light of product specifications and the like of the battery cell 1009 used in the battery portion 1008. The voltage which is raised or lowered by the voltage transformer circuit 1007 is applied as a charging voltage (Vcha) to the terminal pair 1002.

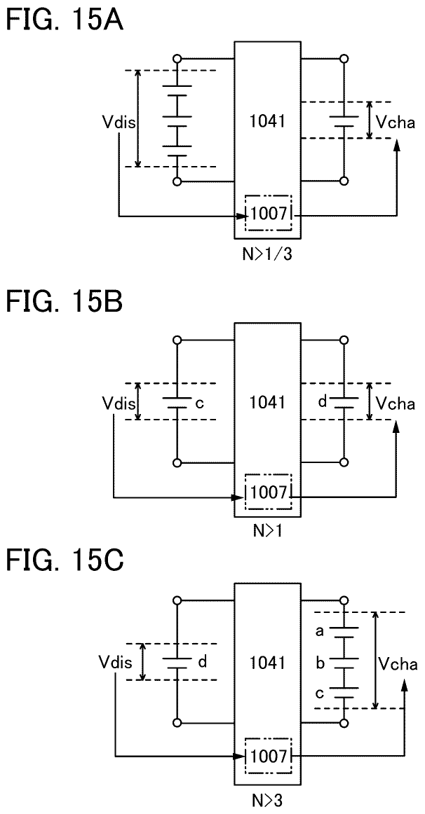

Here, operation examples of the voltage transformation control circuit 1006 in this embodiment are described with reference to FIGS. 15A to 15C. FIGS. 15A to 15C are conceptual diagrams for explaining the operation examples of the voltage transformation control circuit 1006. The discharge battery cell group and the charge battery cell group illustrated in FIGS. 15A to 15C correspond to those in FIGS. 12A to 12C. FIGS. 15A to 15C each illustrate a battery management unit 1041. The battery management unit 1041 includes the terminal pair 1001, the terminal pair 1002, the switching control circuit 1003, the switching circuit 1004, the switching circuit 1005, the voltage transformation control circuit 1006, and the voltage transformer circuit 1007.

In an example illustrated in FIG. 15A, the three consecutive high-voltage cells a to c and one low-voltage cell d are connected in series as described with reference to FIG. 12A. In that case, as described using FIG. 12A, the switching control circuit 1003 determines the high-voltage cells a to c as the discharge battery cell group and the low-voltage cell d as the charge battery cell group. The voltage transformation control circuit 1006 calculates a conversion ratio N for converting the discharging voltage (Vdis) to the charging voltage (Vcha) on the basis of the ratio of the number of the battery cells 1009 included in the charge battery cell group to the number of the battery cells 1009 included in the discharge battery cell group.

In the case where the discharge battery cell group includes more battery cells 1009 than in the charge battery cell group, when a discharging voltage is applied to the terminal pair 1002 without transforming the voltage, overvoltage may be applied to the battery cells 1009 included in the charge battery cell group through the terminal pair 1002. Thus, in the case of FIG. 15A, it is necessary that a charging voltage (Vcha) applied to the terminal pair 1002 be lower than the discharging voltage. In addition, in order to charge the charge battery cell group, it is necessary that the charging voltage be higher than the total voltage of the battery cells 1009 included in the charge battery cell group. Thus, the transformation control circuit 1006 sets the conversion ratio N larger than the ratio of the number of the battery cells 1009 included in the charge battery cell group to the number of the battery cells 1009 included in the discharge battery cell group.

Thus, the voltage transformation control circuit 1006 preferably sets the conversion ratio N larger than the ratio of the number of the battery cells 1009 included in the charge battery cell group to the number of the battery cells 1009 included in the discharge battery cell group by approximately 1% to 10%. Here, the charging voltage is made larger than the voltage of the charge battery cell group, but actual charging voltage is equal to the voltage of the charge battery cell group. Note that the voltage transformation control circuit 1006 feeds a current for charging the charge battery cell group in accordance with the conversion ratio N in order to make the voltage of the charge battery cell group equal to the charging voltage. The value of the current is set by the voltage transformation control circuit 1006.

Since three battery cells 1009 are included in the discharge battery cell group and one battery cell 1009 is included in the charge battery cell group in the example illustrated in FIG. 15A, the voltage transformation control circuit 1006 calculates a value which is slightly greater than 1/3 as the conversion ratio N. Then, the voltage transformation control circuit 1006 outputs the voltage transformation signal S3, which lowers the discharging voltage in accordance with the conversion ratio N and converts the voltage into a charging voltage, to the voltage transformer circuit 1007. The voltage transformer circuit 1007 applies the charging voltage which is transformed in response to the voltage transformation signal S3 to the terminal pair 1002. Then, the battery cells 1009 included in the charge battery cell group are charged with the charging voltage applied to the terminal pair 1002.

In each of examples illustrated in FIGS. 15B and 15C, the conversion ratio N is calculated in a manner similar to that of FIG. 15A. Since the number of the battery cells 1009 included in the discharge battery cell group is less than or equal to the number of the battery cells 1009 included in the charge battery cell group in each of the examples illustrated in FIGS. 15B and 15C, the conversion ratio N is greater than 1. Therefore, in this case, the voltage transformation control circuit 1006 outputs the voltage transformation signal S3 for raising the discharging voltage and converting the voltage into the charging voltage.

The voltage transformer circuit 1007 converts the discharging voltage applied to the terminal pair 1001 into a charging voltage on the basis of the voltage transformation signal S3. The voltage transformer circuit 1007 applies the converted charging voltage to the terminal pair 1002. Here, the voltage transformer circuit 1007 electrically insulates the terminal pair 1001 from the terminal pair 1002. Accordingly, the voltage transformer circuit 1007 prevents a short circuit due to a difference between the absolute voltage of the negative electrode terminal of the battery cell 1009 on the most downstream side of the discharge battery cell group and the absolute voltage of the negative electrode terminal of the battery cell 1009 on the most downstream side of the charge battery cell group. Furthermore, the voltage transformer circuit 1007 converts the discharging voltage, which is the total voltage of the discharge battery cell group, into the charging voltage on the basis of the voltage transformation signal S3, as described above.

An insulated direct current-direct current (DC-DC) converter or the like can be used in the voltage transformer circuit 1007. In that case, the voltage transformation control circuit 1006 outputs a signal for controlling the on/off ratio (duty ratio) of the insulated DC-DC converter as the voltage transformation signal S3 to control the charging voltage converted by the voltage transformer circuit 1007.

Examples of the insulated DC-DC converter include a flyback converter, a forward converter, a ringing choke converter (RCC), a push-pull converter, a half-bridge converter, and a full-bridge converter. A suitable converter is selected in accordance with the intended output voltage.

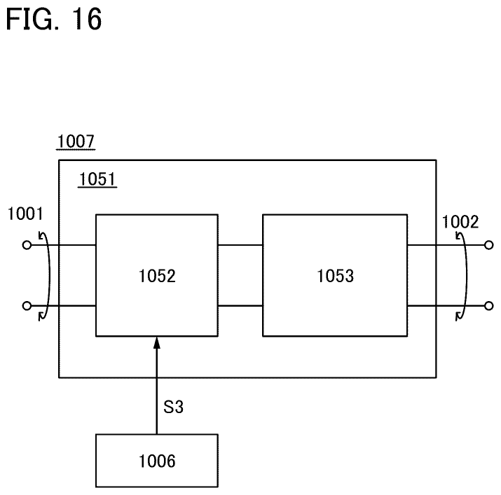

The structure of the voltage transformer circuit 1007 including the insulated DC-DC converter is illustrated in FIG. 16. An insulated DC-DC converter 1051 includes a switch portion 1052 and a transformer 1053. The switch portion 1052 is a switch for switching on/off the insulated DC-DC converter, and a metal oxide semiconductor field-effect transistor (MOSFET), a bipolar transistor, or the like is used as the switch portion 1052. The switch portion 1052 periodically turns on and off the insulated DC-DC converter 1051 in accordance with the voltage transformation signal S3 which is output from the voltage transformation control circuit 1006 and is for controlling the on/off ratio. The switch portion 1052 can have any of various structures depending on the type of the insulated DC-DC converter which is used. The transformer 1053 converts the discharging voltage applied from the terminal pair 1001 into the charging voltage. In detail, the transformer 1053 operates in conjunction with the on/off state of the switch portion 1052 and converts the discharging voltage into the charging voltage in accordance with the on/off ratio of the switch portion 1052. The charging voltage is increased as a period during which the switch portion 1052 is on becomes longer in its switching period. In the case of using the insulated DC-DC converter, the terminal pair 1001 and the terminal pair 1002 can be insulated from each other inside the transformer 1053.

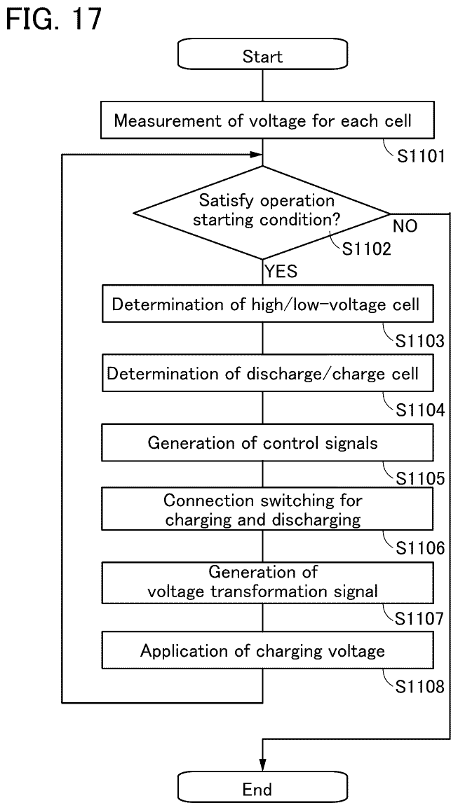

A flow of operation of the power storage device 1000 of this embodiment is described with reference to FIG. 17. FIG. 17 is a flow chart illustrating the operation of the power storage device 1000.

First, the power storage device 1000 obtains a voltage measured for each of a plurality of the battery cells 1009 (Step S1101). Then, the power storage device 1000 determines whether or not the condition for starting the operation of reducing variation in voltages of a plurality of the battery cells 1009 is satisfied (Step S1102). An example of the condition can be that the difference between the maximum value and the minimum value of the voltage measured for each of a plurality of the battery cells 1009 is higher than or equal to the predetermined threshold value. In the case where the condition is not satisfied (Step S1102: NO), the power storage device 1000 does not perform the subsequent steps because voltages of the battery cells 1009 are well balanced. In contrast, in the case where the condition is satisfied (Step S1102: YES), the power storage device 1000 performs the operation of reducing variation in the voltages of the battery cells 1009. In this operation, the power storage device 1000 determines whether each battery cell 1009 is a high-voltage cell or a low-voltage cell on the basis of the measured voltage of each cell (Step S1103). Then, the power storage device 1000 determines a discharge battery cell group and a charge battery cell group on the basis of the determination result (Step S1104). In addition, the power storage device 1000 generates the control signal S1 for setting the determined discharge battery cell group as the connection destination of the terminal pair 1001, and the control signal S2 for setting the determined charge battery cell group as the connection determination of the terminal pair 1002 (Step S1105). The power storage device 1000 outputs the generated control signals S1 and S2 to the switching circuit 1004 and the switching circuit 1005, respectively. Then, the switching circuit 1004 connects the terminal pair 1001 and the discharge battery cell group, and the switching circuit 1005 connects the terminal pair 1002 and the discharge battery cell group (Step S1106). The power storage device 1000 generates the voltage transformation signal S3 on the basis of the number of the battery cells 1009 included in the discharge battery cell group and the number of the battery cells 1009 included in the charge battery cell group (Step S1107). Then, the power storage device 1000 converts the discharging voltage applied to the terminal pair 1001 into a charging voltage on the basis of the voltage transformation signal S3 and applies the charging voltage to the terminal pair 1002 (Step S1108). In this manner, an electric charge of the discharge battery cell group is transferred to the charge battery cell group.

Although a plurality of steps are shown in order in the flow chart of FIG. 17, the execution order of the steps is not limited to the order.

With this embodiment, unlike in the a capacitor type circuit, a structure for temporarily storing an electric charge from the discharge battery cell group and then sending the stored electric charge to the charge battery cell group is unnecessary to transfer an electric charge from the discharge battery cell group to the charge battery cell group. In addition, the switching circuit 1004 and the switching circuit 1005 determine which battery cell in the discharge battery cell group and the charge battery cell group to be connected to the transformer circuit.

Furthermore, the voltage transformer circuit 1007 converts the discharging voltage applied to the terminal pair 1001 into the charging voltage on the basis of the number of the battery cells 1009 included in the discharge battery cell group and the number of the battery cells 1009 included in the charge battery cell group, and applies the charging voltage to the terminal pair 1002. Thus, even when any battery cell 1009 is selected as the discharge battery cell group and the charge battery cell group, an electric charge can be transferred without any problems.

Furthermore, the use of OS transistors as the transistor 1010 and the transistor 1013 can reduce the amount of electric charge leaking from the battery cell 1009 which does not belong to the charge battery cell group or the discharge battery cell group. Accordingly, a decrease in capacity of the battery cell 1009 which does not contribute to charging or discharging can be suppressed. In addition, since the variation in characteristics of the OS transistor due to heat is smaller than that of a Si transistor, an operation such as turning on or off the transistors in response to the control signals S1 and S2 can be performed normally even when the temperature of the battery cells 1009 is increased.

This embodiment can be implemented in combination with any of the other embodiments as appropriate.

### Example 1

One embodiment of the present invention will be specifically described below with an example. This example shows results of manufacture of a positive electrode by the method described in Embodiment 2. Note that the present invention is not limited to the following example.

### Synthesis of Positive Electrode Active Material

First, a lithium-manganese composite oxide was synthesized as a positive electrode active material. Starting materials Li₂CO₃, MnCO₃, and NiO were weighed so that the molar ratio of Li₂CO₃ to MnCO₃ and NiO was 0.84:0.8062:0.318. Next, acetone was added to the powder of these materials, and then, they were mixed in a ball mill to prepare mixed powder.

After that, heating was performed to evaporate acetone, so that a mixed material was obtained.

Then, the mixed material was put in a crucible and was baked to synthesize a material. The baking was performed at 1000 □C for 10 hours in the air at a flow rate of 10 L/min.

Subsequently, grinding was performed to separate the sintered particles. For the grinding, acetone was added to the baked particles and then mixing was performed in a ball mill.

After the grinding, heating was performed to evaporate acetone, so that a lithium-manganese composite oxide containing nickel was formed.

### Manufacture of Electrode A

To manufacture an electrode A, a lithium-manganese composite oxide was used as a positive electrode active material, L-ascorbic acid was used as a reducing agent, graphene oxide (GO) was used as a raw material of a conductive additive, acetylene black (AB) was used as a second conductive additive, PVdF was used as a binder, and NMP was used as a solvent. First, the lithium-manganese composite oxide, GO, AB, and NMP were mixed to form a first mixture. Then, the L-ascorbic acid which was dissolved in a small amount of water was added to the first mixture, mixing was performed, and heating was performed at 80 □C for 1 hour, to reduce GO, so that a second mixture was formed. After that, PVdF was added to the second mixture and they were mixed to form a positive electrode paste. Note that the amounts of materials for the positive electrode paste were adjusted such that the compounding ratio of the lithium-manganese composite oxide to graphene, AB, the L-ascorbic acid, and PVdF became 89:0.5:4.5:1:5 (weight ratio). The positive electrode paste was applied to a current collector (aluminum) and heating was performed at 250 □C so as to evaporate a solvent contained in the positive electrode paste, whereby the electrode A was completed. The supported amount of the positive electrode paste with respect to the current collector was 6 mg/cm².

### Manufacture of Comparative Example B

For comparison, a comparative example B was manufactured in which GO was reduced only by heating without using a reducing agent. First, a lithium-manganese composite oxide, GO, AB, and NMP were mixed to form a first mixture. Then, PVdF was added to the first mixture and they were mixed to form a positive electrode paste. Note that the amounts of materials for the positive electrode paste were adjusted such that the compounding ratio of the lithium-manganese composite oxide to GO, AB, and PVdF became 90:0.5:4.5:5. The positive electrode paste was applied to a current collector (aluminum) and GO was reduced at the same time when a solvent was evaporated by heating at 250 □C, whereby the comparative example B was completed. The supported amount of the positive electrode paste with respect to the current collector was 6 mg/cm².

### Manufacture of Half Cell

Half cells were fabricated using the manufactured electrode A and comparative example B and were used to measure the charge and discharge characteristics. Note that a half cell refers to a cell of a lithium-ion secondary battery in which an active material other than a lithium metal is used for a positive electrode and a lithium metal is used for a negative electrode. Here, a lithium metal was used for a negative electrode, polypropylene (PP) was used for a separator, and an electrolytic solution formed in such a manner that lithium hexafluorophosphate (LiPF₆) was dissolved at a concentration of 1 mol/L in a solution in which ethylene carbonate (EC) and diethyl carbonate (DEC) were mixed at a volume ratio of 1:1 was used.

### Evaluation of Cycle Characteristics

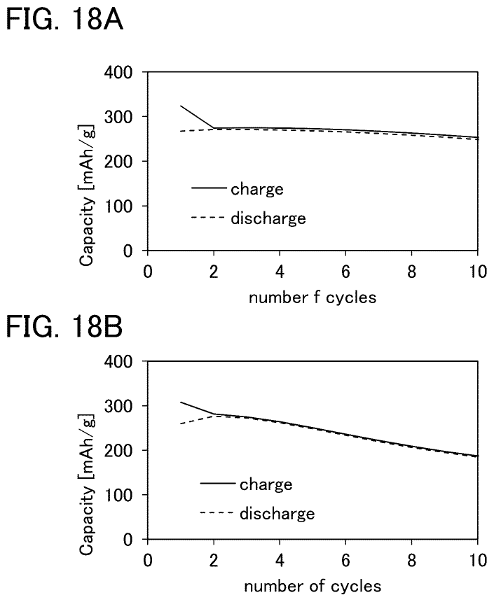

FIGS. 18A and 18B show measurement results of charge and discharge capacities. The longitudinal axis and the lateral axis in each of FIGS. 18A and 18B represent capacity (mAh/g) and the number of cycles, respectively. Charging was performed at a constant current at a charge rate of 0.2 C until the voltage reached a termination voltage of 4.8 V. Discharging was performed at a constant current at a discharge rate of 0.2 C until the voltage reached a termination voltage of 2.0 V. The measurement was performed for ten cycles. FIG. 18A shows the cycle characteristics of the half cell fabricated using the electrode A, and FIG. 18B shows the cycle characteristics of the half cell fabricated using the comparative example B.

Here, a charge rate and a discharge rate are described. A charge rate of 1 C means a current value with which charging is terminated in exactly 1 hour in the case of charging a cell at a constant current. Since the theoretical capacity of each half cell in this example was 150 mAh/g, 1 C was 150 mA/g. Furthermore, 0.2 C means a current value at which charging is terminated in exactly 5 hours in the case of charging a cell at a constant current, and means 30 mA/g in the case of the half cell having the above theoretical capacity. Similarly to the above, a discharge rate of 1 C means a current value at which discharging is terminated in exactly 1 hour in the case of discharging a cell at a constant current. A discharge rate of 1 C of the half cell fabricated in this example was 150 mA/g and a discharge rate of 0.2 C was 30 mA/g.

As apparent from FIGS. 18A and 18B, a reduction in capacity due to an increase in the number of cycles is smaller in the half cell including the electrode A than in the half cell including the comparative example B. This suggests that the electrode A had higher electrical conductivity than the comparative example B. It is thus assumed that a reduction of GO by addition of a reducing agent and heating for forming a positive electrode active material layer allowed an increase in reduction efficiency of GO, and that a network of three-dimensional electric conduction paths was constructed in the active material layer as a result.

### Evaluation of Rate Characteristics

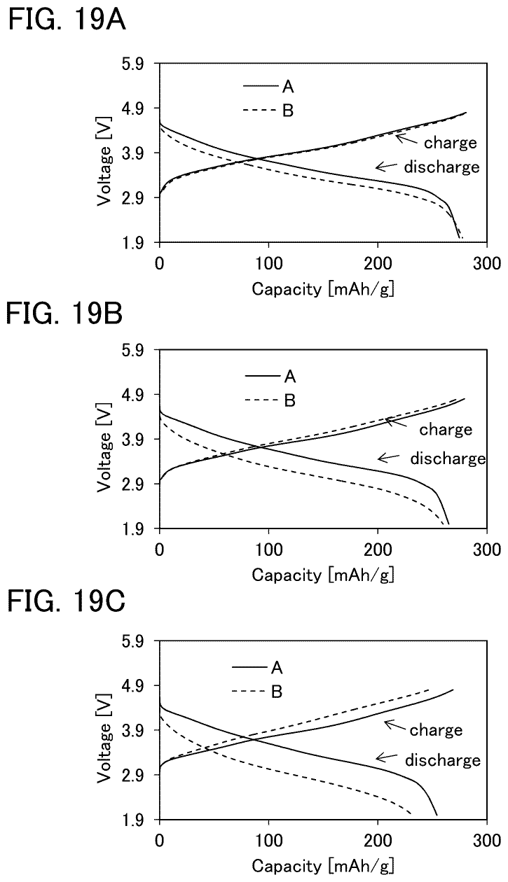

FIGS. 19A to 19C show measured discharge curves of the half cells fabricated using the electrode A and the comparative example B at different discharge rates. The longitudinal axes each represent voltage (V) and the lateral axes each represent charge and discharge capacities (mAh/g). Charging was performed at a constant current at a charge rate of 0.2 C. FIG. 19A shows charge curves and discharge curves at a discharge rate of 0.2 C. FIG. 19B shows charge curves and discharge curves at a discharge rate of 0.5 C. FIG. 19C shows charge curves and discharge curves at a discharge rate of 1.0 C.

FIGS. 19A to 19C show that the discharge capacity and voltage of the half cell including the comparative example B is significantly decreased as the discharge rate is increased. In contrast, the discharge capacity and voltage of the half cell including the electrode A are found to be hardly decreased even when the discharge rate is increased. The results reveal that the electrode A has lower resistance than the comparative example B. Accordingly, it is suggested that when GO is reduced using a reducing agent before a positive electrode active material layer is completed, the reduction efficiency of GO can be increased.

### Resistance Measurement by Current-Rest-Method

Next, the electrode A and the comparative example B were evaluated by measuring the resistance by a current-rest-method. Here, the current-rest-method is described. During charging of a battery, voltage drops when charging is stopped. The internal impedance of the battery is a factor of this voltage drop. The ohmic components of the internal impedance of the half cell including the electrode A and the half cell including the comparative example B were calculated from the formula {(voltage immediately after charging stop)—(voltage 3 seconds after charging stop)} /current and compared to each other. Charging was performed at a constant current at a charge rate of 0.2 C. Charging was stopped at every 15 mAh/g rise in capacity. The ohmic components of the internal impedance were calculated by stopping current when the charge capacity of each battery reached 195 mAh/g, 210 mAh/g, 225 mAh/g, and 240 mAh/g. Table 1 shows the results.

TABLE 1

| | | Capacity in charging stop [mAh/g] | | | |
|---|---|---|---|---|---|
| | | 195 | 210 | 225 | 240 |
| Ohmic component of | A | 50.5 | 82.6 | 68.8 | 82.6 |
| internal impedance [Ω] | B | 99.1 | 111 | 118 | 125 |

The results in Table 1 indicate that the ohmic component of the internal impedance of the half cell including the electrode A is smaller than that of the half cell including the comparative example B. This reveals that the electrode A has lower resistance than the comparative example B. Accordingly, it is suggested that addition of a reducing agent for forming a positive electrode active material layer allows an increase in the reduction efficiency of GO and manufacture of an electrode with a small ohmic component of the internal impedance.

This application is based on Japanese Patent Application serial no. 2014-217227 filed with Japan Patent Office on Oct. 24, 2014, the entire contents of which are hereby incorporated by reference.

What is claimed is:

1. A lithium-ion secondary battery comprising:
a positive electrode comprising an active material layer comprising:
an active material comprising a NiMn-based compound; and
a conductive additive; and
a negative electrode,
wherein the conductive additive comprises at least two of particle-like, flake-like, needle-like, or fiber-like material.
